(19) United States
(12) Patent Application Publication
(10) Pub. No.: US 2025/0299043 A1
(43) Pub. Date: Sep. 25, 2025

(54) INFORMATION PROCESSING APPARATUS, INFORMATION PROCESSING METHOD, AND STORAGE MEDIA

(71) Applicant: CANON KABUSHIKI KAISHA, Tokyo (JP)

(72) Inventors: YOSHINORI MIZOGUCHI, Tokyo (JP); TAKASHI NAKAMURA, Kanagawa (JP); KAZUFUMI KONDO, Kanagawa (JP); TAKAYUKI YAMADA, Kanagawa (JP); AKITOSHI YAMADA, Kanagawa (JP); HISASHI ISHIKAWA, Chiba (JP)

(21) Appl. No.: 19/081,815

(22) Filed: Mar. 17, 2025

(30) Foreign Application Priority Data
Mar. 19, 2024 (JP) 2024-043531

(51) Int. Cl. G06N 3/082; G06N 3/0464; G06V 10/77; G06V 10/82

(52) U.S. Cl. CPC G06N 3/082; G06N 3/0464; G06V 10/7715; G06V 10/82

(57) ABSTRACT

An information processing apparatus includes at least one memory storing a plurality of convolution layers and a processor connected to the at least one memory. The processor propagates output data based on a feature quantity vector extracted from input data from a preceding stage side at each convolution layer to a subsequent stage side; concatenates a forward propagation path with a bypass path that bypasses the forward propagation path; performs processing of extracting the feature quantity vector from the input data at each convolution layer; in the processing of extracting the feature quantity vector, performs, as re-extraction processing, processing of re-extracting the feature quantity vectors included in convolution layers up to a convolution layer where bypassing through the bypass path starts; and in a case where the re-extraction processing is performed, concatenates an output result from the forward propagation path with a result of the re-extraction processing.

### BACKGROUND

### Field of the Disclosure

The present disclosure relates to an information processing apparatus, an information processing method, and a storage media.

### Description of the Related Art

Conventionally, skip connections have been performed in training of neural networks. A skip connection is a configuration in deep neural networks that allows forward propagation or backward propagation between distant layers through a bypass path that skips a plurality of intermediate layers and concatenates to subsequent layers. Skip connections have the aspect of improving the vanishing gradient problem while decreasing generalization performance of a neural network. Thus, a technology that selects a skip connection to be disabled and blocks error propagation only for the selected skip connection is disclosed in International Publication No. WO2019/167665 (hereinafter referred to as Literature 1). In the technology disclosed in Literature 1, processing of selecting a skip connection to be disabled is performed in each training of a neural network. This makes it possible to repeatedly perform training using neural networks with different schemes of concatenation between layers. Thus, with the technology disclosed in Literature 1, it is possible to achieve ensemble training, which overall improves generalization performance of a neural network.

The above-described skip connection also has the aspect of requesting retention of previous processing results. Generally, as the more processing results are retained, a larger circuit area is used as storage space. Thus, the technology disclosed in Literature 1 has the aspect of overall improving generalization performance of a neural network but also has the aspect of requiring increasing costs along with an increase in the circuit area used as storage space. For example, a cache memory used to retain processing results is often constituted by a static random access memory (SRAM), which is typically expensive. Accordingly, it is desirable not to increase the circuit area used as storage space of an SRAM. However, in a case where the circuit area used as storage space of an SRAM is not increased, storage space of a memory for retaining processing results are potentially insufficient so that the above-described skip connection cannot be achieved.

### SUMMARY

An information processing apparatus according to an aspect of the present disclosure is an information processing apparatus: at least one memory storing a plurality of convolution layers; and a processor connected to the at least one memory. The processor propagates output data based on a feature quantity vector extracted from input data from a preceding stage side at each of the plurality of convolution layers to a subsequent stage side, concatenates a forward propagation path that sequentially propagates the output data through each convolution layer between some convolution layers and other convolution layers among the plurality of convolution layers and a bypass path that bypasses the forward propagation path in a case of propagating the output data from the some convolution layers to the other convolution layers, performs processing of extracting the feature quantity vector from the input data at each of the plurality of convolution layers, in the processing of extracting the feature quantity vector, performs, as re-extraction processing, processing of re-extracting the feature quantity vectors included in convolution layers up to a convolution layer where bypassing through the bypass path starts among the plurality of convolution layers, and in a case where the re-extraction processing is performed in the processing of extracting the feature quantity vector, concatenates an output result from the forward propagation path and a result of the re-extraction processing performed by the processing of extracting the feature quantity vector in the concatenating the forward propagation path and the bypass path.

Further features of various embodiments will become apparent from the following description of exemplary embodiments with reference to the attached drawings.

### BRIEF DESCRIPTION OF THE DRAWINGS

FIG. 1 is a block diagram illustrating the configuration of an inference execution apparatus.

FIG. 2 is a conceptual diagram illustrating an example of the configuration of an inference unit.

FIG. 3 is a schematic diagram illustrating the configuration of a skip connection.

FIG. 4 is a circuit conceptual diagram of a filter included in the inference unit.

FIG. 5 is a schematic diagram illustrating the vicinity of an input section of a CNN.

FIG. 6 is a flowchart for description of an overview of processing performed in a convolution layer.

FIG. 7 is a schematic diagram illustrating details of a neuron included in the CNN.

FIG. 8 is a flowchart for description of convolution processing.

FIG. 9 is a schematic diagram illustrating the vicinity of an output section of the CNN.

FIG. 10 is a circuit conceptual diagram of the filter included in the inference unit.

FIG. 11 is a conceptual diagram illustrating images used for training.

FIG. 12 is a circuit conceptual diagram of the filter included in the inference unit.

FIG. 13 is a flowchart for description of training.

FIG. 14 is a flowchart illustrating re-extraction operation.

FIG. 15 is a diagram illustrating an example in which a feature quantity vector of the fifth layer is skip-connected.

FIG. 16 is a circuit conceptual diagram of the filter included in the inference unit.

FIG. 17 is a schematic diagram of CNN processing.

FIG. 18 is a circuit conceptual diagram of the filter included in the inference unit.

FIG. 19 is a schematic diagram for description of a skip connection using dimensionally reduced feature quantity vectors.

FIG. 20 is a schematic diagram of a model that performs a skip connection.

FIG. 21 is a schematic diagram for description of details of a skip connection.

FIG. 22 is a diagram illustrating a setting screen for training a CNN model.

FIG. 23 is a diagram illustrating an example of a detailed setting screen for training the CNN model.

FIG. 24 is a diagram illustrating another example of the detailed setting screen for training the CNN model.

FIG. 25 is a flowchart illustrating automated CNN model designing.

### DESCRIPTION OF THE EMBODIMENTS

Example embodiments of the present disclosure will be described below in detail with reference to the accompanying drawings. The embodiments below do not limit every embodiment of the present disclosure, and combinations of features described in the embodiments below are not necessarily essential to the solutions of the present disclosure. Identical constituent components are denoted by the same reference sign.

### First Embodiment

### Overview

It is generally known that as training of a neural network is repeated, gradients calculated in error backward propagation become smaller and eventually vanish, which is referred to as the vanishing gradient problem. Skip connections are performed to solve the vanishing gradient problem. A skip connection is a configuration in deep neural networks that allows forward propagation or backward propagation between distant layers through a bypass path that skips a plurality of intermediate layers and concatenates to subsequent layers. In a skip connection, a bypass path that skips some of a plurality of layers constituting a neural network is provided such that the bypass path and a forward propagation path are provided in parallel. With such a path configuration, it is possible to skip some of the plurality of layers and propagate a feature to a distant layer through another path. Thus, it is possible to propagate features, which would vanish through convolution processing and the like performed in layers on the preceding stage side of the plurality of layers, to the subsequent stage side of the plurality of layers. However, to achieve a skip connection, it is needed to retain a feature quantity vector extracted in each layer. Accordingly, in a case where a skip connection is performed, the larger storage space of a memory is needed as compared to a case where no skip connection is performed. Furthermore, in a case where the feature quantity vectors of layers is retained and used for processing as necessary in a skip connection, the feature quantity vectors are retained in a cache memory rather than a main memory to ensure processing efficiency. Accordingly, a larger cache memory is needed. Typically, an SRAM is used as the cache memory, but is expensive. Thus, in the present embodiment, an operation described below is performed instead of retaining the feature quantity vector extracted in each layer to achieve a skip connection at low cost. Specifically, processing of obtaining input data from the main memory to the cache memory again and re-extracting the feature quantity vector of each layer between the first layer and a corresponding layer is performed as re-extraction processing. With such operation, it is possible to achieve a skip connection without increasing the circuit area used as storage space of an SRAM, which is expensive. The model configuration of a neural network is not particularly limited. The model configuration may be, for example, a convolution neural network constituting an encoder-decoder model. Also, the model configuration may be Inverted Residual, found in a model such as ResNet.

Main terms used in the present specification are defined in advance as follows.

### Term Definition

### Artificial Neuron:

A processing unit constituted by a filter and an activation function unit. The convolution coefficient of the filter is also referred to as a “weight”. In addition, the convolution coefficient of the filter is also referred to as the “weight of the artificial neuron” as appropriate. The artificial neuron receives input data for the filter. For example, for a 3×3 filter, the artificial neuron receives input data of 5×5, forwards a convolved value to the activation function unit, and outputs a feature quantity calculated by the activation function unit.

### Activation Function Unit:

A function with non-linear response characteristics. A sigmoid function is used, but a rectified linear unit (ReLU) function may be used. In a case where a function with non-linear response characteristics is used, the input-output relation has non-linear response characteristics, but the present disclosure is not particularly limited thereto. The activation function unit may be, for example, a function with linear response characteristics. Also, the activation function unit may be the identify function. For example, the activation function unit may be achieved by the identify function in a case where a feature quantity vector is transferred to a distant layer through a skip connection.

### Layer:

A processing unit made of a plurality of artificial neurons. The same data is input to each artificial neuron in principle. However, the convolution coefficient (weight) of each artificial neuron may be set to a different weight in accordance with a feature to be obtained. The reason for being constituted by a plurality of artificial neurons is to analyze input data from multiple perspectives.

### Feature Quantity:

An output from one artificial neuron is referred to as a feature quantity. Different artificial neurons output different feature quantities. Feature quantities may be output from artificial neurons as certain indicators, such as intensity.

### Feature Quantity Vector:

A vector made of a plurality of feature quantities output from one layer. The dimensionality of the vector is referred to as a “channel” in the following description.

### Prior Art

Embodiments of the disclosure will be described below with reference to the accompanying drawings. In an embodiment described in the present embodiment, it is assumed that an EdgeAI terminal has externally trained required training results in advance in order to perform inference. The EdgeAI terminal is a product that, as a standalone product, can benefit from results of artificial intelligence. The EdgeAI terminal does not necessarily need to have both “training” and “inference”, which are required for a convolution neural network (CNN). The product can achieve “inference” by retaining parameters as training results prepared in advance. CNN is a type of pattern recognition using machine learning. Furthermore, CNN is one of processing methods by which manufacturers enhance functionality for product differentiation. An overview of operations by which a CNN achieves pattern recognition will be described below.

### Overview of CNN Operation

First, features of input data are extracted according to a feature quantity extraction method prepared in advance. The feature quantity extraction method will be described below. Feature quantity extraction can be achieved through extensive convolution processing using a multi-stage filter. The multi-stage filter is constituted by a plurality of filters and a plurality of activation function units. Each of the plurality of activation function units is disposed on the subsequent stage side of the corresponding one of the plurality of filters. A pair of one filter and one activation function unit corresponds to an “artificial neuron” defined as described above. The activation function unit is, for example, a function that non-linearly responds to input. Each filter has a convolution coefficient. A method of determining the convolution coefficients will be described below. The convolution coefficients can be determined in advance by using an extensive amount of data with the aim of determining a pattern type. Specifically, the convolution coefficients can be determined by preparing an extensive amount of correct answer data and optimizing the convolution coefficients until the accuracy of unknown data as correct answer becomes high. Hereinafter, such a determination method is referred to as “training”. The feature quantities of the input data are extracted through extensive convolution processing performed by using the convolution coefficients obtained as results of training. The feature quantities obtained from the input data in this manner are obtained at artificial neurons and thus not limited to a single kind. At least some feature quantities among a plurality of feature quantities of input data correspond to “feature quantity vectors” defined as described above. In this manner, a CNN extracts the feature quantity vectors from the input data.

Subsequently, the CNN identifies which predetermined pattern type the feature quantity vectors match based on outputs from the final layer of the CNN. In this manner, the input data is classified into a known pattern. Accordingly, pattern recognition is achieved. Such pattern recognition corresponds to the above-described “inference”.

The CNN may be achieved by an encoder-decoder model constituted by an encoding layer and a decoding layer. The attributes of each pixel may be determined on a per-pixel basis by using the encoder-decoder model. The encoder-decoder model determines attributes for all pixels in an image. Thus, attributes can be determined on a per-pixel basis by using the encoder-decoder model. Hereinafter, such processing is referred to as “region partition”. Also, such processing may be referred to as “segmentation”. “Segmentation” corresponds to what is called semantic segmentation. It is possible to identify whether consecutive pixels correspond to the same target by aggregating determination results of the attributes of each pixel on a per-pixel basis. Specifically, the encoding layer performs downsampling on input data to extract feature quantities in a large area. The decoding layer derives a definitive determination result while performing upsampling to the same resolution as that of input data with extracted feature quantities. The CNN configured as the encoder-decoder model has, for example, characteristics as follows. One characteristic is that input data reaches a definitive determination result through an extremely large number of layers. As a result, resolution changes in intermediate layers of processing, which is another characteristic.

There is another characteristic as follows. Each artificial neuron used in the CNN includes the above-described filter. The above-described filter performs convolution processing on input data. The filter has a convolution coefficient as described above. The convolution coefficient is what is called “weight”. In the CNN, a feature quantity obtained through a model is compared with a true value. Specifically, in the CNN, the difference between a calculated feature quantity and a true value is calculated. The difference is referred to as “error”. A method of calculating the “weight” so that the error decreases is referred to as an error backward propagation method. In addition, optimization of the convolution coefficient by repeatedly using the error backward propagation method is a specific example of the above-described “training”. In this manner, determination of the convolution coefficients through training is another characteristic of the CNN.

### Skip Connection

These characteristics potentially cause phenomena as follows. For example, a phenomenon may occur where error backward propagation does not correctly proceed during training. The reason is that as layers become deeper, results of processing by the error backward propagation method decrease and training does not proceed. Hereinafter, such a phenomenon is referred to as a “vanishing gradient”. Also, a phenomenon may occur where information indicating local features of input data retained during encoding is lost due to change in resolution each time the data passes through each layer. These phenomena may cause accuracy degradation during training. As a countermeasure against such accuracy degradation during training, a “skip connection” has been conventionally used. In a case of an encode-decode model, a skip connection can be implemented by using data from the encoding layer again in convolution processing of the decoding layer. Such operation improves the quality of information during decoding by using information that is lost during encoding. At the same time, such operation achieves preferable error backward propagation during training, including feedback components generated by a skip connection. Thus, it is possible to perform training that recovers local edges lost during encoding. It is also possible to accurately determine region boundaries of an image. However, in a case where a skip connection is performed, for example, results of processing in the encoding layer need to be passed to the decoding layer. Accordingly, as a layer used during encoding proceeds, results of processing in each artificial neuron are retained in an SRAM. The reason is that all results of encoding, which are to be used during decoding, need to be stored in the SRAM.

The CNN is usable in image recognition. In a case where the CNN is used in image recognition, it is sufficient to perform convolution processing on the entire image. A specific example of filters used in convolution processing will be described below. For example, it is assumed that one 3×3 filter is applied to an image. Convolution processing is processing of assigning the sum of products of convolution coefficients and pixels included in the image to the value of the center pixel. Thus, only the value of the center pixel is determined in a case where a 3×3 filter is applied to a 3×3 image. If the 3×3 filter is to be applied to adjacent pixels surrounding the 3×3 image, a 5×5 image is needed. In this manner, surrounding pixels needed in processing during convolution in accordance with a needed image region are hereinafter referred to as “margins”. A larger number of margins are needed as the size of each filter increases and the number of stacks of two-dimensional filters in layers across the entire CNN increases. Accordingly, the number of necessary margins three-dimensionally increases. The use amount of storage space of a memory needs to be increased in accordance with such margin increase. For example, in convolution processing, data obtained from the main memory is loaded onto the cache memory. Typically, an SRAM is used as the cache memory. Accordingly, the use amount of storage space of the SRAM increases in a situation where the number of margins increases. In particular, in a case where multiple large-scale filters are stacked, the use amount of storage space of the SRAM three-dimensionally increases as compared to one or two filters.

As described above, extensive SRAM storage space is needed to perform convolution processing using filters through multiple layers. Furthermore, extensive SRAM storage space is also needed to perform a skip connection. For example, in a case of the encoder-decoder model, data reliability during decoding can be improved by performing a skip connection, but necessary SRAM storage space exponentially increases. Since an SRAM is expensive, a significant increase in the storage space of the SRAM results in high cost. However, without an increase in SRAM storage space, the cache memory required for skip connection is insufficient. Although an example of a skip connection in the encoder-decoder model is described above, a skip connection normally requires a large cache memory for any other model as well, and thus it has been unable to perform a skip connection at low cost. Thus, in the present embodiment, configurations and operations that enable a skip connection at low cost will be sequentially described below.

### Overall Inference Execution Apparatus

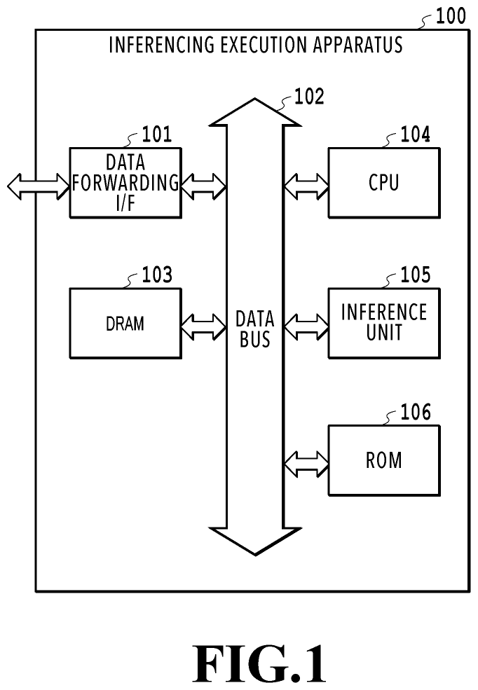

FIG. 1 is a block diagram illustrating the configuration of an inference execution apparatus. This inference execution apparatus 100 is an information processing apparatus mounted on a product body. In the present embodiment, the product body is assumed to be a printer. However, the product body in which the inference execution apparatus is implemented is not limited to a printer, but a product such as a personal computer or a smartphone that incorporates a processing circuit such as a CPU or a similar ASIC or FPGA can adopt the configuration of the present embodiment. The inference execution apparatus 100 includes a data forwarding I/F 101, a data bus 102, and a dynamic random access memory (DRAM) 103. The inference execution apparatus 100 also includes a central processing unit (CPU) 104, an inference unit 105, and a read-only memory (ROM) 106. The data forwarding I/F 101 is an interface that performs data inputting and outputting with a non-illustrated external instrument outside the product. The external instrument is, for example, an instrument, such as a personal computer or a cellular phone, which can generate or hold input data and forward input data to the product body. The data bus 102 is a data bus for forwarding various kinds of data received from the data forwarding I/F 101 to functional blocks to be described later. The DRAM 103 is a region that temporarily stores various kinds of data received from the data forwarding I/F 101. The CPU 104 communicates input data stored in the DRAM 103 through the data bus 102 and performs necessary processing. The inference unit 105 is a functional block that receives data partitioned into image blocks and performs inference inside. The inference unit 105 includes an SRAM. The ROM 106 is a region that holds various kinds of data provided to the inference unit 105. The ROM 106 can store, for example, convolution coefficients determined based on results of training in advance. The ROM 106 also stores the size of image blocks passed from the DRAM 103 to the inference unit 105 as described later. These configurations are exemplary, and for example, an optional storage medium may be used in place of the ROM 106. The optional storage medium may be, for example, an HDD or an external memory through a USB interface. In the present embodiment, inference is performed in the inference unit 105. However, firmware for implementing an equivalent mechanism may be stored in a storage medium and processed by the CPU 104. As part of functionality extension, the size of image blocks passed from the DRAM 103 to the inference unit 105 through the data forwarding I/F 101 may be communicated as a parameter.

### Inference Unit

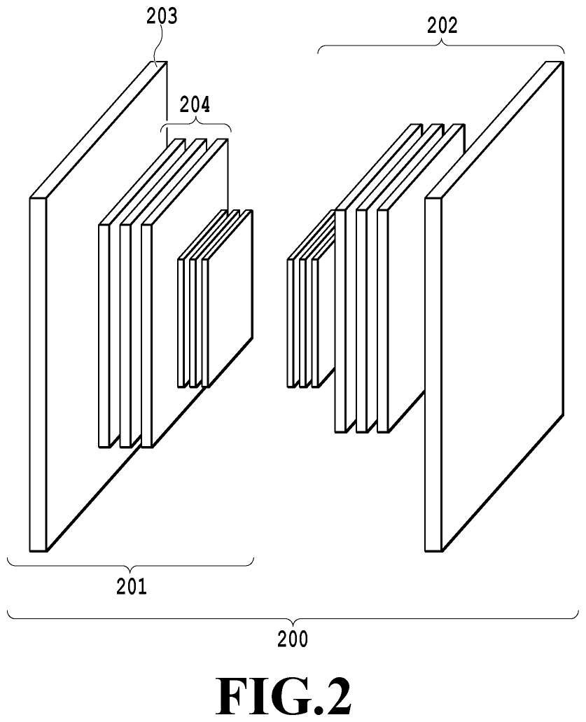

FIG. 2 is a conceptual diagram illustrating an example of the configuration of the inference unit 105. The inference unit 105 in FIG. 2 is assumed to operate in accordance with the encoder-decoder model. The encoder-decoder model is, for example, SegNet or U-Net. The inference unit 105 implements functional configurations as an inference execution unit 200 by means of the CPU 104 executing various computer programs. The inference execution unit 200 includes an encoding layer 201 and a decoding layer 202. The encoding layer 201 includes an input layer 203 and a processing layer 204. The encoding layer 201 encodes features of input data. The decoding layer 202 decodes processing results obtained in the encoding layer 201 and extracts feature quantity vectors. Input data is input to the input layer 203. A layer is a single functional unit that performs specific processing by consecutively using a large number of filters in a CNN model. A plurality of filters do not necessarily needed as a physical configuration. Gradually updating convolution coefficients and providing processing results to processing in the next filter constitutes two consecutive filter processes. Here, the input layer 203 is illustrated as an example of such a layer. The processing layer 204 is a layer for receiving input data provided from the input layer 203 and implementing processing thereafter. Through such processing, encoding is achieved in the first half. These subsequent layers are configured by using a plurality of filters like the input layer. Similarly to the encoding side, the decoding side has a configuration with a processing layer including a plurality of filters. In the example of FIG. 2, each layer is illustrated as a cube having quadrilateral surfaces, with its size indicating resolution. Specifically, it is indicated that resolution decreases on the encoding side as layer processing proceeds and resolution increases on the decoding side as layer processing proceeds. The following describes consecutive use of a large number of filters. Definitive output from the decoding side is uniquely determined through processing by the activation function unit in the final layer. The probability of pixel attributes is determined by results of processing by the activation function unit. In the example of FIG. 2, since the encoder-decoder model is assumed, description of the decoding layer of the CNN is omitted. In the example of FIG. 2, the CNN constitutes multiple layers by combining a plurality of two-dimensional filters. Configured layers are combined to perform encoding and decoding. Feature quantity vectors are obtained through these processes. The inference unit 105 in FIG. 2 assumes the encoder-decoder model, but the model is not particularly limited thereto. For example, a ResNet model may be assumed. In a case of the ResNet model, fully-connected layers and an output layer are provided after a plurality of convolution layers and pooling layers are provided on the subsequent stage side of the input layer.

### Overview of Skip Connection

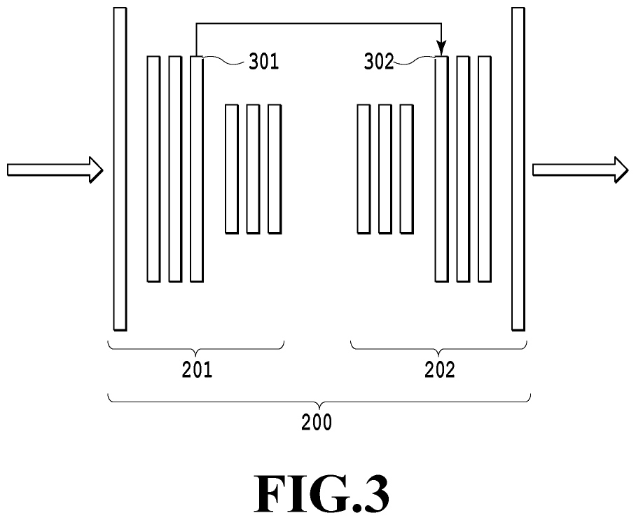

A skip connection will be described below. FIG. 3 is a schematic diagram illustrating the configuration of a skip connection. In the present embodiment, the encoding layer 201 is illustrated as seven quadrilaterals in the diagram. Each of the seven quadrilaterals represents a layer. Each layer includes a plurality of artificial neurons. The length of each quadrilateral represents the resolution of input data. Specifically, the resolution of the input data decreases as the length of a quadrilateral decreases. The resolution of input data increases as the length of a quadrilateral increases. Accordingly, FIG. 3 exemplarily illustrates a case where the encoding layer 201 is made of seven layers. The configuration of layers is not limited thereto. Each layer may be configured by combining artificial neurons to extract a desired feature quantity. Convolution processing through sum-of-products operation processing is performed in a convolution layer, and aggregation of a representative value from the result of the convolution processing is performed in a pooling layer. As a result, the input data is thinned while feature quantities of the input data are extracted, and as a result, compression processing (hereinafter also referred to as downsampling) of the input data is performed. In other words, the downsampling is pooling performed by aggregating a representative value from a plurality of values obtained by the convolution processing in accordance with a particular algorithm. The particular algorithm for performing pooling is, for example, processing of calculating the average value of a plurality of values obtained by the convolution processing. Accordingly, the plurality of values obtained by the convolution processing are aggregated to one representative value. Also, the particular algorithm is processing of calculating a maximum value among the plurality of values obtained by the convolution processing. Accordingly, the plurality of values obtained by the convolution processing are aggregated to one representative value. In this manner, performance degradation with changes in the positions of coordinates in an image can be prevented by performing pooling. In a case where no pooling layers are used, downsampling may be performed by increasing the movement width (stride) of filters scanned during convolution and obtaining the feature quantities of a scaled-down image as a result. With any method, it is possible to obtain a feature quantity vector as an output value from an optional layer during encoding. This is the same for a processing layer on the decoding side. However, an upsampling layer is used as processing of expanding feature quantity resolution in the decoding layer. In normal processing, data is input to the input layer 203 and the processing proceeds on the subsequent stage side of the input layer. This processing direction is forward propagation direction. An output layer 301 is a layer that outputs a feature quantity vector at this stage. A dimension addition layer 302 is a layer that adds a dimension by using a feature quantity vector output from the output layer 301. Next follows a description of dimension addition. Typically, the dimension of a sum obtained as a result of addition of an n-th vector and another n-th vector is n. Mathematical addition is not defined for an n-th vector and an m-th vector. We stipulate that dimension addition does not mean vector addition but means simple arrangement of vectors with different dimensions to generate an (n+m)-th vector. Such processing is referred to as “dimension concatenation” in the following description. Such a processing method of arranging output from an optional layer on the encoding side to add a dimension at inputting to an optional layer on the decoding side is referred to as a skip connection. In other words, a skip connection is operation that increases the number of vector components. Processing of expanding data by interpolation may be performed in the upsampling layer. Also, processing of expanding data may be performed by transposed convolution processing or upsampling convolution processing.

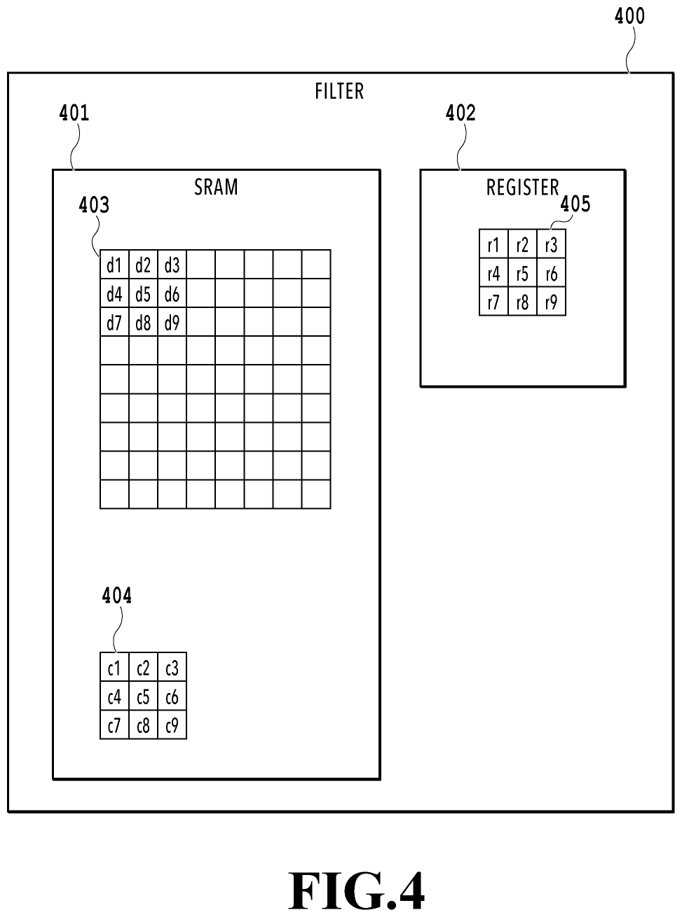

Based on the above, an information processing apparatus in the present embodiment has a configuration below irrespective of model. Specifically, the information processing apparatus includes a convolution layer set, a concatenation unit, and a processing unit. The convolution layer set includes a plurality of convolution layers. The convolution layer set propagates output data based on a feature quantity vector extracted from input data from the preceding stage side at each of the plurality of convolution layers to the subsequent stage side. The preceding stage side means a preceding stage right before each convolution layer. The subsequent stage side means a subsequent stage right after each convolution layer. The concatenation unit is implemented by the CPU 104 in FIG. 1. The concatenation unit concatenates a forward propagation path and a bypass path. The forward propagation path sequentially propagates the output data through each convolution layer between some convolution layers and other convolution layers among the plurality of convolution layers. The bypass path bypasses the forward propagation path in a case of propagating the output data from the some convolution layers to the other convolution layers. The processing unit is implemented by the CPU 104 in FIG. 1. The CPU 104 in FIG. 1 extracts the feature quantity vector from the input data in each of the plurality of convolution layers. The CPU 104 in FIG. 1 performs, as the re-extraction processing, processing of re-extracting feature quantity vectors included in convolution layers up to a convolution layer where bypassing through the bypass path starts among the plurality of convolution layers. The concatenation unit concatenates an output result from the forward propagation path and a result of the re-extraction processing performed by the processing unit in a case where the processing unit performs the re-extraction processing. With such a configuration, a skip connection can be achieved by re-extracting the feature quantity vector of each layer instead of holding the feature quantity vector of each layer in the forward propagation path in the cache memory. This enables the skip connection at low cost. The input data is constituted by a plurality of elements. The plurality of elements are, for example, a plurality of pixels. Accordingly, the input data is constituted by a plurality of pixels, for example. Each of the plurality of convolution layers includes a filter in which a plurality of convolution coefficients are specified. This filter will be described later with reference to FIGS. 4, 10, 12, 16, and 18. The CPU 104 in FIG. 1 extracts the feature quantity vectors by performing convolution processing based on the plurality of pixels and the plurality of convolution coefficients at each of the plurality of convolution layers. Through such operation, the feature quantity vectors can be extracted by using the filter. Specifically, the CPU 104 in FIG. 1 calculates feature quantities representing local feature quantities of the input data for each shift of the filter by performing sum-of-products operation processing on the input data while shifting the filter with a certain stride and extracts a set of the calculated feature quantities as the feature quantity vectors. Through such operation, the feature quantity vectors can be extracted from the input data by using the filter. Shift of the filter means that a region to be processed with the convolution coefficients of the filter among pixels of the input data loaded onto storage space is shifted with a certain stride. Thus, physical movement of the filter is not meant.

### Filter Circuit Configuration

FIG. 4 is a circuit conceptual diagram of a filter 400 included in the inference unit 105. The filter 400 includes an SRAM 401 and a register 402. In the example of FIG. 4, data 403 and a convolution coefficient data set 404 are loaded onto storage space of the SRAM 401. The data 403 is obtained from the DRAM 103 functioning as a main memory and loaded onto a predetermined storage space in the storage space of the SRAM 401. The data 403 is constituted by pixels d1 to d9. The convolution coefficient data set 404 is constituted by c1 to c9 and disposed in a 3×3 matrix. In the register 402, a data set 405 of r1 to r9 is disposed in a 3×3 matrix as the same disposition configuration as the convolution coefficient data set 404. The data set 405 of r1 to r9 is used to retain a 3×3 positional relation (coordinates) during convolution processing.

### Convolution Coefficient Generation Method

A convolution coefficient generation method will be described below.

### Generation Environment

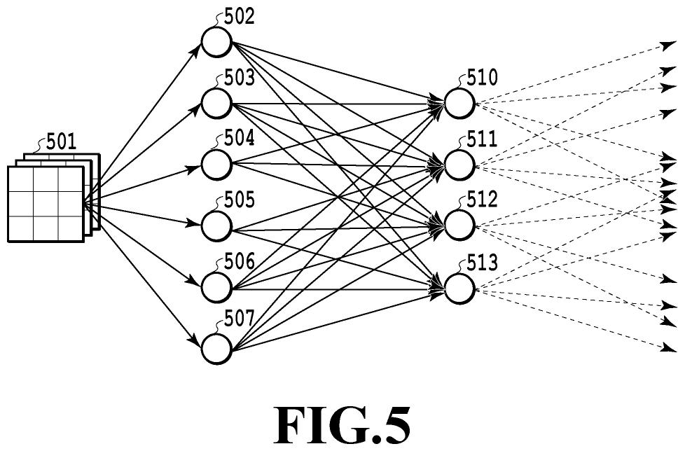

FIG. 5 is a schematic diagram illustrating the vicinity of an input section of the CNN. In the present embodiment, a non-illustrated personal computer may be used as a training execution apparatus for generation. The training execution apparatus is not limited to a personal computer but may be a product such as a printer or a smartphone that incorporates a processing circuit such as a CPU or a similar ASIC or FPGA. Also, the inference execution apparatus 100 may generate convolution coefficients by training.

Data 501 is input data. For example, in a case where the input data is image data, 3×3 pixels with three channels of R, G, and B for each coordinate as in the diagram are prepared as the data 501. Artificial neurons 502 to 507 are elements that process the data 501. The artificial neurons 502 to 507 holds convolution coefficients for convolution of the data 501 in this example. The convolution coefficients are held for the three channels of R, G, and B. As described later, these values at the current stage are generation target variables. For example, the artificial neuron 502 holds 3×3 convolution coefficients for convolution of the data 501 for the three channels of R, G, and B. The artificial neurons 502 to 507 can hold convolution coefficients with different characteristics. This is because one convolution process can extract one feature quantity. A plurality of convolution processes may be performed to extract a plurality of different feature quantities. The present embodiment describes an example in which the first processing layer including the six artificial neurons 502 to 507 and the second processing layer including four artificial neurons 510 to 513 are provided as convolution layers. Upon completion of convolution processing in each of the artificial neurons 502 to 507, the first processing layer including the artificial neurons 502 to 507 can extract six feature quantities to the subsequent stage side. Upon completion of convolution processing in each of the artificial neurons 510 to 513, the second processing layer including the artificial neurons 510 to 513 can extract four feature quantities to the subsequent stage side. In other words, the artificial neurons 510 to 513 receive feature quantities extracted in the respective artificial neurons 502 to 507 from the preceding stage side and similarly perform convolution processing to extract four feature quantities to the subsequent stage side.

### Overview of Training

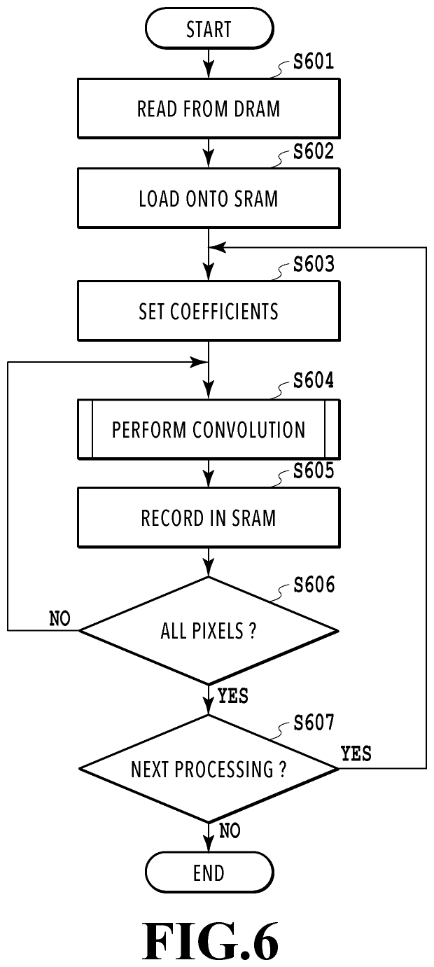

FIG. 6 is a flowchart for description of an overview of processing performed in a convolution layer. The processing illustrated in FIG. 6 may be implemented by the CPU 104. The following describes an example in which the processing is executed by the CPU 104. Functions of some or all steps in FIG. 6 may be implemented by hardware such as ASICs or electronic circuits. Symbol “S” in description of each processing means a step in the flowchart diagram.

The processing illustrated in FIG. 6 is started upon execution of training processing in the convolution layer. At S601, the CPU 104 reads input data from the DRAM 103. At S602, the CPU 104 loads the read input data onto the storage space of the SRAM 401. The CPU 104 reads convolution coefficients based on a computer program prepared in the ROM 106 in advance and loads the read convolution coefficient onto the storage space of the SRAM 401. The input data and the convolution coefficients are preferably loaded onto different storage spaces in the storage space of the SRAM 401. At S603, the CPU 104 sets the convolution coefficients loaded onto the storage space of the SRAM 401 to storage space of the register 402. At S604, the CPU 104 performs convolution processing based on a plurality of pixels included in the input data and the convolution coefficients. Details of processing at S604 will be described later. At S605, the CPU 104 records the result of the convolution processing in the storage space of the SRAM 401. At S606, the CPU 104 determines whether there remains any input data to be processed in the convolution layer based on whether all pixels have been processed. In a case where not all pixels have been processed, the CPU 104 returns processing at S606 to processing at S604. In a case where all pixels have been processed, the CPU 104 advances processing at S606 to processing at S607. At S607, the CPU 104 determines the next filter is needed as the next processing. In a case where the next filter is needed, the CPU 104 returns processing at S607 to processing at S603 and sets convolution coefficients for a file of the second convolution layer to the register 402. Thereafter, at S606, the CPU 104 performs convolution processing on the result of the first convolution layer by using the convolution coefficients of filters in the second convolution layer. Upon completion of processing with all filters in this manner, the CPU 104 ends processing at S607, thereby ending processing at S601 to S607.

### Overview of Artificial Neuron

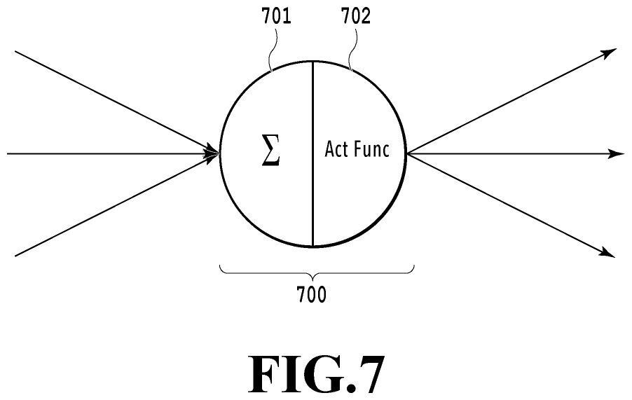

FIG. 7 is a schematic diagram illustrating details of an artificial neuron 700 included in the CNN. The artificial neuron 700 includes a convolution unit 701 and an activation function unit 702. The artificial neuron 700 is included in a convolution layer. The artificial neuron 700 is a single processing mechanism that receives input from the preceding stage side of the convolution layer and performs output to the subsequent stage side of the convolution layer. The convolution unit 701 performs convolution processing by using convolution coefficients. The activation function unit 702 includes a function with non-linear characteristics. Specifically, the activation function unit 702 includes a softmax function or a ReLU function. The activation function unit 702 outputs a result of function processing that receives a result from the convolution unit 701. The output from the activation function unit 702 may be weak depending on the result from the convolution unit 701. In other words, whether to transfer information from the activation function unit 702 to the next layer is determined depending on convolution coefficients used by the convolution unit 701. Such processing is repeatedly performed for the next stages and up to the final stage (not illustrated) of the model to extract feature quantities. In other words, the activation function unit 702 calculates feature quantities as constituent components of a feature quantity vector based on the convolution processing result output from the convolution unit 701. As described above, a level including a plurality of convolution layers is referred to as a convolution layer set. The convolution layer set may include a plurality of pooling layers. Each of the plurality of pooling layers may be disposed on the subsequent stage side of the corresponding one of a plurality of convolution layers to aggregate a feature quantity vector to a representative value as output data. Aggregation is operation that extracts one from among a plurality of feature quantities included in a specific range. For example, a maximum value among the plurality of feature quantities included in the specific range may be extracted. Also, the average value of the plurality of feature quantities included in the specific range may be extracted. In addition, an upsampling layer may be disposed on the subsequent stage side of the convolution layer set. In the upsampling layer, the CPU 104 may expand the output data and enlarge the representative value to the size of the input data and output the expanded output data as subsequent stage data. For example, the upsampling layer enlarges the representative value to the size of the input data by expanding X and Y directions of the output data.

### Convolution Processing

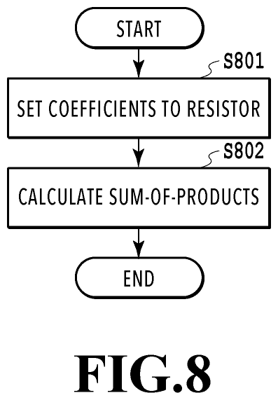

FIG. 8 is a flowchart for description of convolution processing. The processing illustrated in FIG. 8 may be implemented by the CPU 104. The following describes an example in which the processing is executed by the CPU 104. Functions of some or all steps in FIG. 8 may be implemented by hardware such as ASICs or electronic circuits. Symbol “S” in description of each processing means a step in the flowchart diagram.

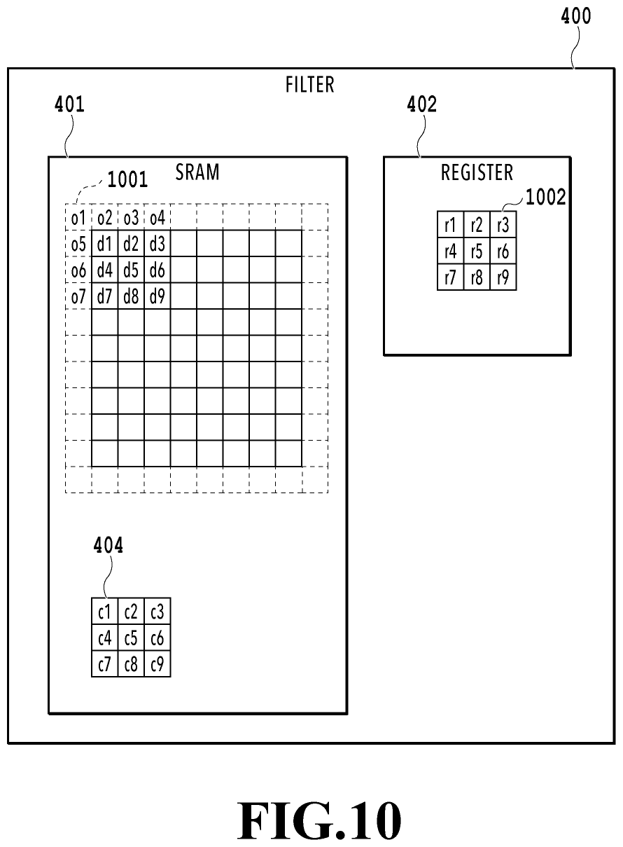

The processing illustrated in FIG. 8 is started upon a call of convolution processing. At S801, the CPU 104 sets convolution coefficients to the register 402. At S802, the CPU 104 multiplies one pixel among a plurality of pixels loaded onto the storage space of the SRAM 401 with the convolution coefficients set to the register 402. The CPU 104 collects and adds multiplication results in the number of elements included in one filter 400. The elements included in the filter 400 are the convolution coefficients. The number of the elements is the number of the convolution coefficients. Convolution processing will be more specifically described with reference to FIG. 10.

### Error Obtainment

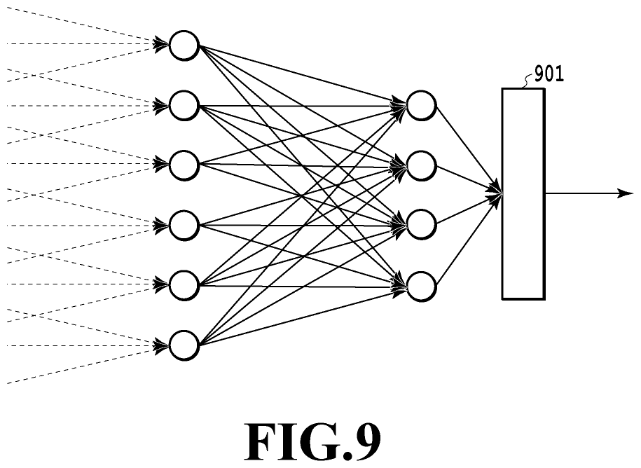

FIG. 9 is a schematic diagram illustrating the vicinity of an output section of the CNN. In the example of FIG. 9, an activation layer 901 is indicated. The activation layer 901 includes the activation function unit 702. As a layer including the artificial neuron 700 in FIG. 7 reaches the final stage, output is made through the activation function unit 702. Through such operation, features of an image input as input data are obtained. Accordingly, the CNN model obtains feature quantities from the input data by using extensive filter calculation and activation function. The entire configuration of a model constituted by processing units each including a filter and an activation function depends on basic designing of a model that is used. In a case where a well-known model is used, it depends on the configuration of the model. In a case of establishing a model from the model structure itself, it is determined how the sizes of filters, the number of artificial neurons 700 including the filters and used at model establishment, and the number of layers constituted by them are determined. True feature quantities indicating features of a subject appearing in image data as the input data may be prepared by another method. For example, a value can be determined through visual determination by a person. Hereinafter, this value is referred to as “correct answer”. In this case, error can be obtained by calculating the difference between a value obtained from the CNN model and the correct answer. An upsampling layer may be disposed on the preceding stage side of the activation layer 901. In other words, the activation layer 901 may be disposed on the subsequent stage side of the upsampling layer. The activation layer 901 may reconstruct subsequent stage image data in which data obtained from the preceding stage side is mapped. In a case where the upsampling layer is disposed on the preceding stage side, the activation layer 901 may obtain subsequent stage data by increasing the size of a representative value to the input data. In a case where no upsampling layer is disposed on the preceding stage side but the convolution layer set is disposed, the activation layer 901 may obtain a representative value by aggregating feature quantity vectors. The CPU 104 may classify a subject appearing in image data constituted by a plurality of pixels based on the subsequent stage image data reconstructed by the activation layer 901. The CPU 104 may calculate convolution coefficients based on the subsequent stage image data reconstructed by the activation layer 901 and the input data.

### Detailed Example of Convolution Processing

FIG. 10 is a circuit conceptual diagram of the filter included in the inference unit 105. As illustrated in FIG. 10, a marginal data set 1001 is provided around the pixels d1, d2, d3, d4, and d7. The marginal data set 1001 includes o1 to o7. The marginal data set 1001 is loaded onto the storage space of the SRAM 401 to determine r1 in the register 402. The value r1 is an index of the corresponding coordinate of convolution processing. Similarly, the value r2 and subsequent values are indexes of the corresponding coordinates of convolution processing. After convolution processing is performed by using the marginal data set 1001 and r1 is determined, the values o1, o5, and o6 are discarded and convolution processing is performed by using o4, d3, and d6 to determine r2 next. Subsequently, convolution processing is similarly performed and the results of the convolution processing are forwarded to the register 402. During the forwarding, parts without pixels are filled with “0” by processing known as padding. With such a margin, it is possible to retain part of position information that would have been lost by convolution processing, thereby improving the certainty of a feature quantity vector.

### Modification 1 of Margin

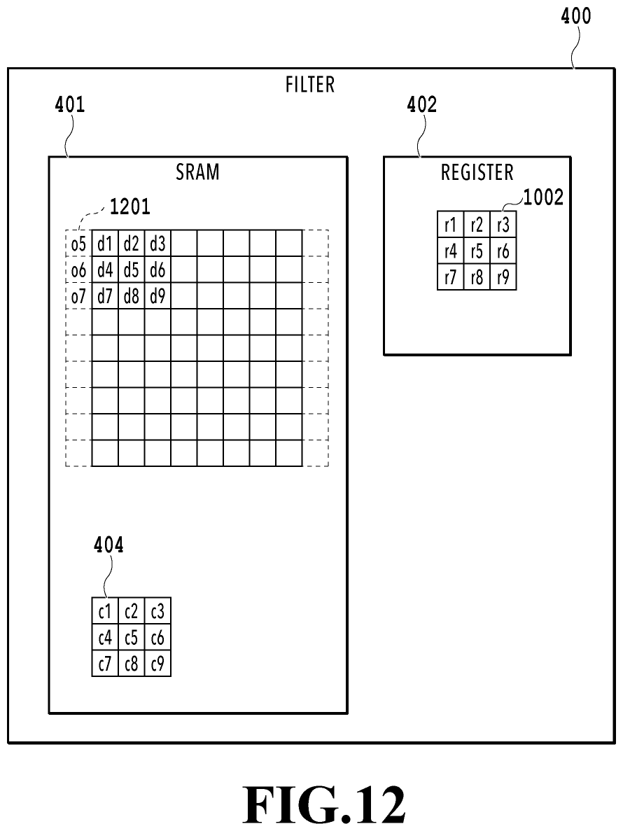

FIG. 12 is a circuit conceptual diagram of the filter included in the inference unit 105. In the example illustrated in FIG. 12, the amount of margin used is reduced as compared to the example illustrated in FIG. 10. In the example of FIG. 12, a margin data set 1201 is disposed on the left side of d1, d4, and d7. In the example of FIG. 12, spatial locality of data disposition in the right-left direction in the storage space of the SRAM 401 is provided by a margin data set 120, and thus it is preferable for data progression in the right-left direction. Moreover, with such a margin as well, it is possible to retain part of position information that would have been lost by convolution processing, thereby improving the certainty of a feature quantity vector.

### Modification 2 of Margin

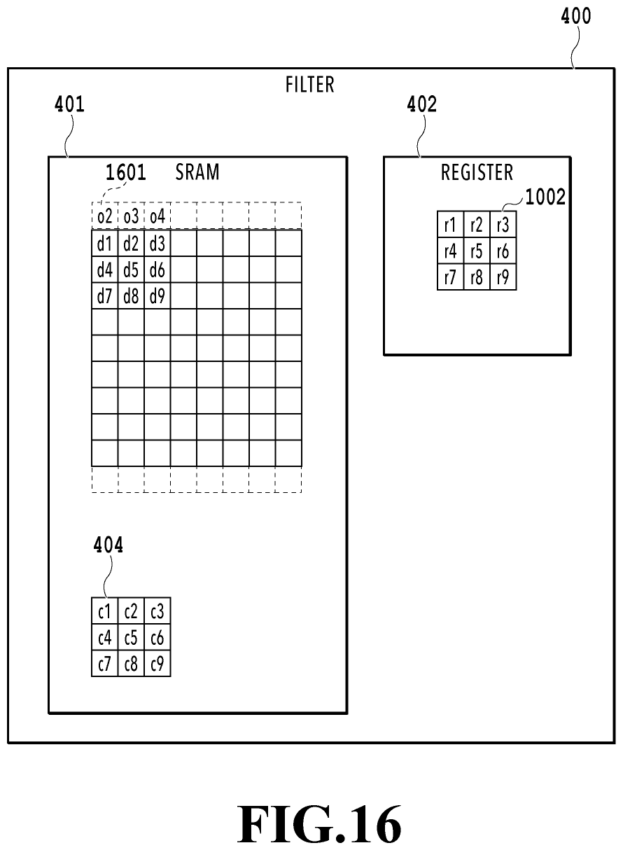

FIG. 16 is a circuit conceptual diagram of the filter included in the inference unit 105. In the example illustrated in FIG. 16, the amount of margin used is reduced as compared to the example illustrated in FIG. 10. In the example of FIG. 16, a margin data set 1601 is disposed on the upper side of d1, d2, and d3. In the example of FIG. 16, spatial locality of data disposition in the longitudinal direction in a record region of the SRAM 401 is provided by the margin data set 1601, and thus it is preferable for data progression in the longitudinal direction. Moreover, with such a margin as well, it is possible to retain part of position information that would have been lost by convolution processing, thereby improving the certainty of a feature quantity vector.

### Modification 3 of Margin

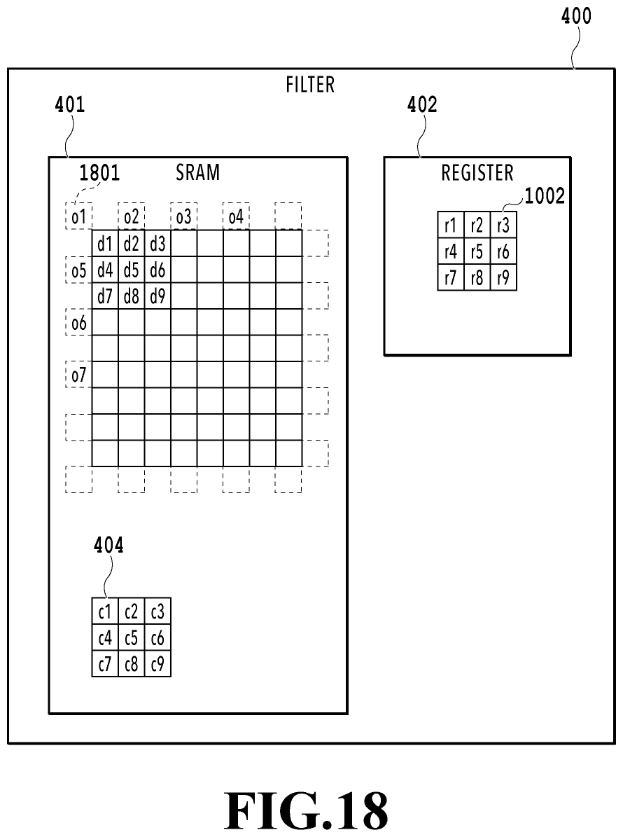

FIG. 18 is a circuit conceptual diagram of the filter included in the inference unit 105. In the example illustrated in FIG. 18, the amount of margin used is reduced as compared to the example illustrated in FIG. 10. In the example of FIGS. 18, o1, o2, o3, and o4 included in a margin data set 1801 are disposed one pixel apart from each other. Moreover, in the example of FIGS. 18, o1, o5, o6, and o7 included in the margin data set 1801 are disposed one pixel apart from each other. In the example of FIG. 18, the spatial locality of data disposition at equal intervals in the record region of the SRAM 401 is provided by the margin data set 1801, and thus it is preferable for data progression at a constant pace. Moreover, with such a margin as well, it is possible to retain part of position information that would have been lost by convolution processing, thereby improving the certainty of a feature quantity vector.

### Training and Processing Unit

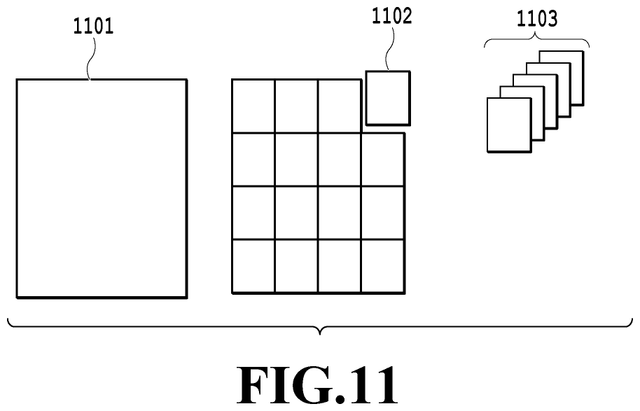

FIG. 11 is a conceptual diagram illustrating images used for training. Image partition and augmentation are described. An original image 1101 is an arbitrary image that serves as the basis for images used for training. In this example, the original image 1101 is partitioned into regions. Partitioned images 1102 are images obtained by partitioning the original image 1101. An augmented image group 1103 is a group of a plurality of images generated by fabricating the partitioned images 1102. For example, they are generated through processing such as mirror flipping or partially overwriting pixels of optional image elements such as pictures, text, or graphics. Details of an augmentation method are omitted.

### Training

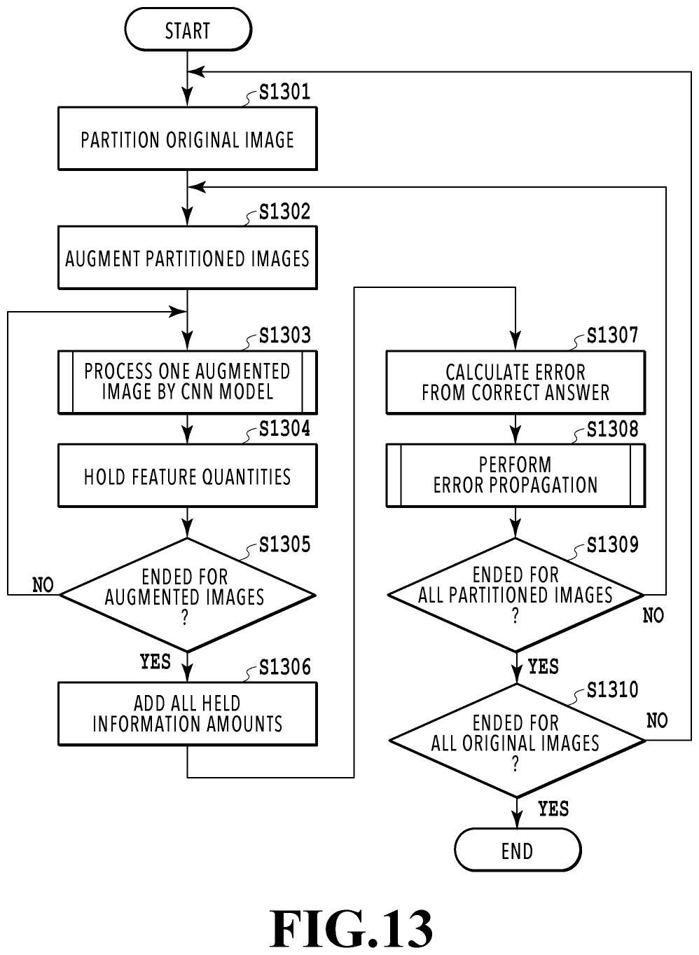

FIG. 13 is a flowchart for description of training. The processing illustrated in FIG. 13 may be implemented by the CPU 104. The following describes an example in which the processing is executed by the CPU 104. Functions of some or all steps in FIG. 13 may be implemented by hardware such as ASICs or electronic circuits. Symbol “S” in description of each processing means a step in the flowchart diagram.

The processing illustrated in FIG. 13 is started upon user input. A specific embodiment of user input will be described in a third embodiment. In the present embodiment, it is assumed that training is performed based on user input. However, in a case where the training execution apparatus and the inference execution apparatus are configured by the same information processing apparatus, the processing may be started based on feedback from the inference execution apparatus.

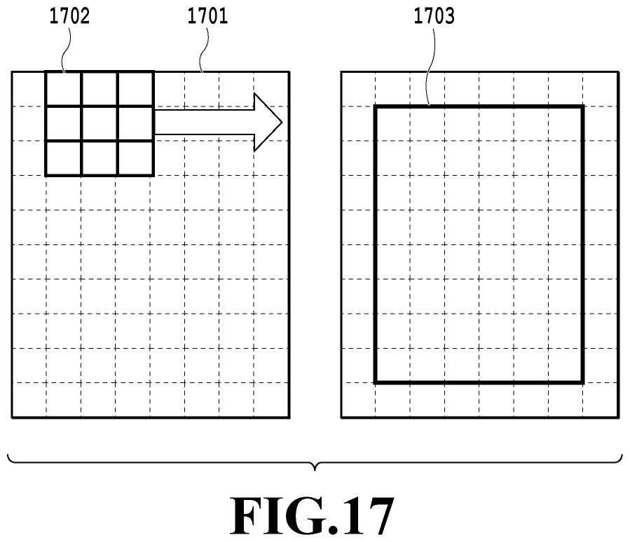

At S1301, the CPU 104 obtains the partitioned images 1102 in FIG. 11 by partitioning a single optional image provided for training into optional number of parts. At S1302, the CPU 104 obtains the augmented image group 1103 in FIG. 11 by augmenting the partitioned images. At S1303, the CPU 104 processes one optional image obtained from the augmented image group 1103 with the CNN model. Through processing at S1303, feature quantities are extracted from the augmented image group 1103. Details of processing at S1303 will be described below with reference to FIG. 17. FIG. 17 is a schematic diagram of CNN processing. FIG. 17 illustrates an example in which a filter 1702 is applied to an augmented enlarged display image 1701 and a calculation result of each pixel is obtained in a bold frame region 1703.

At S1304, the CPU 104 holds the extracted feature quantities. For example, the extracted feature quantities are held in the SRAM 401. At S1305, the CPU 104 determines whether the processing is ended for all augmented images. If the processing is ended for all augmented images, the CPU 104 advances processing at S1305 to processing at S1306. If the processing is not ended for all augmented images, the CPU 104 returns processing at S1305 to processing at S1303. At S1306, the CPU 104 adds all held information amounts. Specifically, all feature quantities held in processing at S1304 are added. Such a feature quantity obtained by adding all feature quantities is referred to as a “summed feature quantity” in the following description. At S1307, the CPU 104 calculates, as an error, the difference between a correct feature quantity added the same number of times as the number of times of augmentation processing, and the summed feature quantity. At S1308, the CPU 104 propagates the error in the direction opposite the forward propagation direction by using the error backward propagation method and updates convolution coefficients specified by the filter included in each convolution layer. The error backward propagation method is a well-known technology, and thus description thereof is omitted. At S1309, the CPU 104 determines whether the error propagation is ended for all partitioned images 1102. If the error propagation is not ended, the CPU 104 returns processing at S1310 to S1302 and starts augmentation for the next partitioned image. In the next processing, convolution coefficients and transposed convolution coefficients on which the result of the error backward propagation executed in the previous processing is reflected are used. By repeating such processing of the error backward propagation, convolution coefficients and transposed convolution coefficients are sequentially optimized. If the error propagation is ended, the CPU 104 advances processing at S1309 to processing at S1310. At S1310, the CPU 104 determines whether the processing is ended for all images. If the processing is not ended, the CPU 104 returns processing at S1310 to processing at S1301 and performs partition of another original image. If the processing is ended, the CPU 104 ends processing at S1310 to S1310. In this manner, calculation of convolution coefficients and transposed convolution coefficients used in the model by propagating the error between a known correct answer and a feature quantity vector obtained from the model in the direction opposite the forward propagation direction is referred to as training. By storing convolution coefficients and transposed convolution coefficients obtained in this manner in the ROM 106 of the product body as parameters in advance, it is possible to perform inference in the product body. In the present embodiment, image augmentation is performed after image partition, but some embodiments are not particularly limited thereto. Specifically, augmentation of an original image may be performed first, and thereafter, image partition may be performed.

### Execution of Inference

The parameters thus obtained are output as the probability of a recognition result for what kind of image the input data represents. In this manner, it is possible to identify a pattern by evaluating the degree of matching with a pattern type as probability. In the present embodiment, convolution using two-dimensional image data and a two-dimensional filter is described above as an example. However, usage is not limited thereto. Specifically, the same configuration may be applied, for example, in a case where a one-dimensional filter is used for pattern recognition from one-dimensional temporally sequential data such as voice. Also, the same configuration may be applied in a case where a three-dimensional filter is used for pattern recognition from three-dimensional data using voxels. Moreover, the same effects of the present application can be obtained typically by having a preferable configuration in accordance with the dimensions of feature quantities.

### Details of Skip Connection

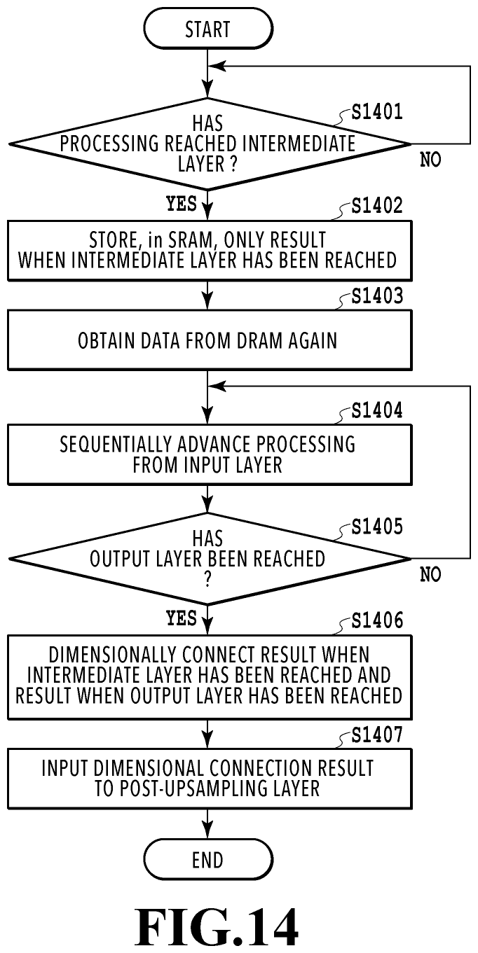

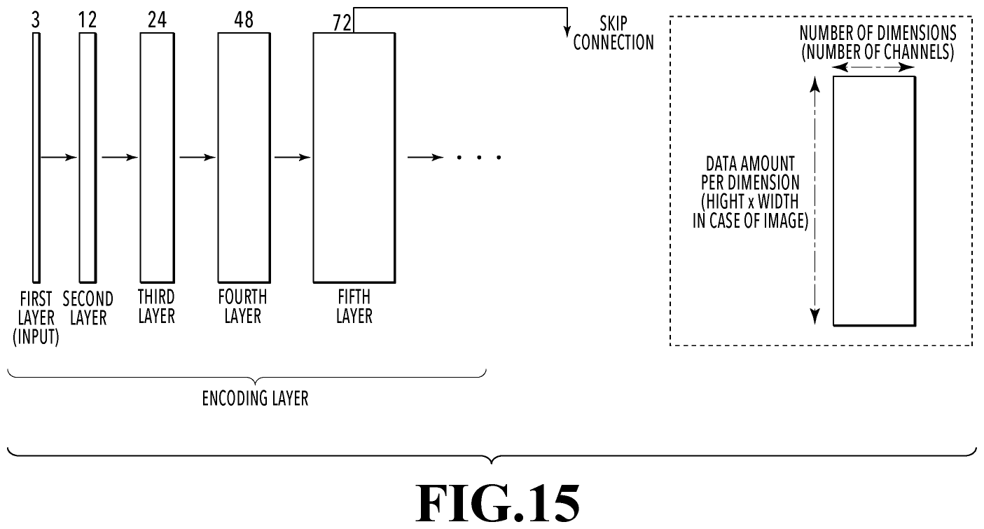

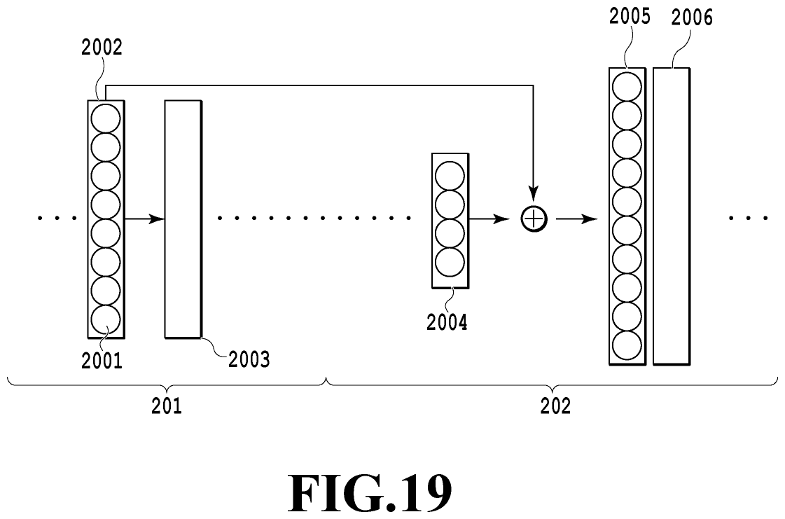

Details of a skip connection will be described below with reference to FIGS. 14, 15, 19, and 20. First, the configuration of a skip connection will be described with reference to FIGS. 19, 20, and 15, and an operation example of a skip connection will be described with reference to FIG. 14. FIG. 19 is a schematic diagram for description of a skip connection using a dimensionally reduced feature quantity vector. FIG. 19 illustrates an example in which the encoding layer 201 includes an output layer 2002 and a next layer 2003. FIG. 19 also illustrates an example in which the decoding layer 202 includes an intermediate layer 2004, a post-upsampling layer 2005, and a next layer 2006. The post-upsampling layer 2005 has the same function as the above-described upsampling layer. The intermediate layer 2004 is the final layer as a skip target of the skip connection and includes a convolution layer. Specifically, a bypass path starting at the non-illustrated input layer and bypassing the output layer 2002 to the intermediate layer 2004, and a forward propagation path from the non-illustrated input layer to the intermediate layer 2004 are formed. Convolution layers included in the bypass path are convolution layers included up to the output layer 2002. Although not illustrated, convolution layers are disposed on the preceding stage side of the output layer 2002. For example, in a case where the model is SegNet or U-Net, a plurality of convolution layers and pooling layers are disposed on the preceding stage side of the output layer 2002. For example, information passed in the skip connection is the entire feature quantities in a case where the model is U-Net, but information passed in the skip connection is the indexes of pooling coordinates in a case where the model is SegNet. The indexes of pooling coordinates are information indicating the positions of pooling. Although FIG. 19 illustrates an example in which a plurality of artificial neurons 2001 are included in the output layer 2002, artificial neurons are included in each of the next layer 2003, the intermediate layer 2004, the post-upsampling layer 2005, and the next layer 2006 as well. Focusing on one artificial neuron 2001, the artificial neuron 2001 receives a feature quantity vector from a non-illustrated layer disposed on the preceding stage side and calculates a feature quantity. This feature quantity is defined as one channel. For example, the output layer 2002 outputs a 8-channel feature quantity vector. Analysis of the input data is processed in the forward propagation direction. Thus, the eight channels of feature quantities are input to the next layer 2003. On the decoding side, a feature quantity vector is input from the intermediate layer 2004 to the post-upsampling layer 2005. In this case, the feature quantity vector from the output layer 2002 and the feature quantity vector from the intermediate layer 2004 are dimensionally concatenated. Next follows a description of the feature quantity vector from the output layer 2002, which is provided for the skip connection. In the present embodiment, the number of channels of the feature quantity vector is reduced. For example, among the three channels of R, G, and B, the R channel is discarded and only the two channels of G and B are dimensionally concatenated. In other words, the dimension of the feature quantity vector provided for skip connection is restricted to one channel to seven channels. The effect of the skip connection is more likely to be obtained as the number of channels is larger. Moreover, used SRAM storage space can be reduced as the number of channels is larger. The reason is that processing of sequentially rewriting the convolution coefficients held in the SRAM storage space for one filter while holding processing results is included to perform the skip connection. Moreover, performing the skip connection by thinning channels has the effect of reducing the held processing results. The feature quantity vectors dimensionally concatenated in this manner are input to the post-upsampling layer 2005. The result of processing therein is input to the next layer 2006 in the decoding layer 202. In this manner, it is possible to reduce the use amount of the SRAM storage space along with the skip connection. In the channel thinning, channels to be thinned may be selected. For example, a method of collectively thinning consecutive channels or a method of discretely thinning channels may be selected. Although the example with eight channels is described above, the number of channels is optional. Moreover, layers to be concatenated may be optionally selected. In the present embodiment, the example in which the channels of feature quantity vectors are thinned to reduce the use amount of the SRAM storage space along with the skip connection is described above. However, thinning targets do not depend only on the number of channels as long as the use amount of the SRAM storage space along with the skip connection can be reduced. For example, the data length of feature quantity vectors may be thinned. For example, from among eight bits of RGB, four bits are selected and the remaining four bits are discarded. In this manner, restricting the data length of feature quantity vectors to less than the original data length of feature quantity vectors has the effect of reducing the use amount of the SRAM storage space along with the skip connection. Also, a method of thinning the number of feature quantities of a calculation result 903 for pixels in the bold frame region 1703 in FIG. 17 has the effect of reducing the use amount of the SRAM storage space along with the skip connection.

The error propagation is performed from the post-upsampling layer 2005 to the intermediate layer 2004 in the direction opposite the forward propagation direction, and convolution coefficient are updated to weights with which the error is minimized while the vanishing gradient is reduced. This point is further described. The output layer 2002 originally outputs a feature quantity vector with eight channels. However, in establishment of the CNN model using machine learning, it is impossible to determine which channels are preferable for data analysis. Thus, processing of multiplying preferable channels with strong weights is performed by training. Thus, optimization of the weights of remaining channels not thinned results in skip connection using only significant channels. Also, the intensity (amplitude) of each frequency is obtained by expanding one-dimensional data into a Fourier series. In this case, with what is called a low-pass filter, high-frequency components can be cut off, but this is not the case with machine learning. Training is performed so that the weights (coefficients) of significant frequency bands become strong in accordance with input. As a result, feature quantity vectors in the skip connection can be limited to significant channels in dimension reduction. Thus, it is possible to reduce performance degradation while reducing the use amount of the SRAM storage space. Initial convolution coefficients in a case where the convolution coefficients are optimized by using such an error backward propagation method may be arbitrary values.

To perform skip connection, outputs from neurons of each layer need to be temporarily held in the SRAM storage space. As described above, this temporary storage space in the SRAM storage space is unnecessary if skip connection is not performed. Thus, as processing reaches a layer that needs skip connection, needed output from the encoding layer may be re-extracted (also referred to as regeneration as appropriate). Specifically, as processing reaches the intermediate layer 2004, the CPU 104 holds only its result in the storage space of the SRAM 401. In addition, the CPU 104 obtains input data from the DRAM 103 again and advances processing in the forward propagation direction from the input layer 203. Upon reaching the output layer 2002, the CPU 104 dimensionally concatenates results held from the intermediate layer 2004 and inputs the concatenated results to the post-upsampling layer 2005. In performing inference, the CPU 104 can reduce the use amount of the SRAM storage space by CNN through such operation. To reduce the use amount of the SRAM storage space, the method of advancing processing in the forward propagation direction from the input layer 203 to re-extract output from the encoding layer 201, which is needed for dimension concatenation is described above. However, it is not necessarily needed to advance processing in the forward propagation direction from the input layer 203 in a case of performing re-extraction. For example, a feature quantity vector output from the output layer 2002 in the encoding layer 201 may be held in the SRAM storage space to start processing from then feature quantity vector. This example will be described below with reference to FIG. 15.

### Modification of Skip Connection

FIG. 15 is a diagram illustrating an example in which the feature quantity vector of the fifth layer is skip-connected. In the example illustrated in FIG. 15, a plurality of layers are disposed in the encoding layer. In each layer, processing proceeds in the forward propagation direction. As processing proceeds in the forward propagation direction, the number of dimensions (the number of channels) increases. The feature quantities of a layer for which the number of dimensions is 24 can be held. With such operation, it is sufficient to restart calculation from the layer for which the number of dimensions is 24, and thus it is possible to increase calculation efficiency. In the example of FIG. 15, a model including the encoding layer is illustrated, but the subsequent stage side of the encoding layer is not particularly limited. For example, a model in which the decoding layer is disposed on the subsequent stage side of the encoding layer may be adopted. Also, a model constituted only by the encoding layer or the decoding layer may be adopted.

In the present example so far, the method of thinning feature quantities to reduce feature quantities held in the SRAM storage space is described as the method of reducing the use amount of the SRAM storage space along with the skip connection. In addition, the method of not holding feature quantities needed for skip connection in the SRAM but re-extracting feature quantities upon reaching a layer in need of them is described above. Which method is used to reduce the use amount of the SRAM storage space can be selected for each layer. The effect of reducing the use amount of the SRAM storage space along with the skip connection is higher with the method of re-extracting feature quantities upon reaching a layer in need of them. The reason is that it is possible to perform skip connection without retaining feature quantities for skip connection in the SRAM storage space. Thus, it is preferable to use the method of re-extracting feature quantities from the perspective of the effect of reducing the use amount of the SRAM storage space. However, the processing amount increases with this method. The reason is that processing once performed needs to be performed again to re-extract feature quantities. Which method is to be selected for each layer involves a trade-off between the use amount of the SRAM storage space and processing speed. The reason is that as the processing amount increases, processes with inherent parallelism can be simultaneously executed, resulting in overall increase in processing speed.

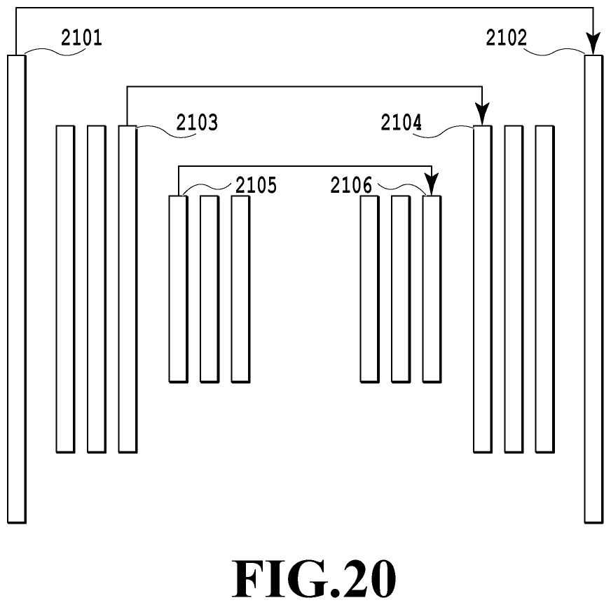

FIG. 20 is a schematic diagram of a model that performs skip connection. In a case where feature quantities are re-extracted for dimension connection, the processing amount for re-extraction increases as layers in the encoding layer proceed in the forward propagation direction. In FIG. 20, output layers 2101, 2103, and 2105 are disposed, and it is assumed that at least one convolution layer is disposed on the preceding stage side of each output layer. The output layer 2101 is concatenated to a dimension concatenation layer 2102 by skip connection. The output layer 2103 is concatenated to a dimension concatenation layer 2104 by skip connection. The output layer 2105 is concatenated to a dimension concatenation layer 2106 by skip connection. The following describes re-extraction of output from each of the output layers 2101, 2103, and 2105. A path with skip connection at the output layer 2101 is a path that allows calculation with the smallest processing amount. A path with skip connection at the output layer 2105 is a path with the largest processing amount. In the present embodiment, dimension concatenation is performed in the dimension concatenation layer 2102 by using a method of re-extracting a feature quantity vector output from the output layer 2101. The reason is that the output layer 2101 has fewer convolution layers disposed on the preceding stage side as compared to the output layers 2103 and 2105, and thus the effect of largely reducing the use amount of the SRAM storage space along with the skip connection while keeping the processing amount necessary for re-extraction is obtained. In addition, dimension concatenation is performed in the dimension concatenation layer 2104 and the dimension concatenation layer 2106 by using a method of thinning feature quantity vectors output from the output layer 2103 and the output layer 2105 and holding the thinned feature quantity vectors in the SRAM. The reason is described by using an example of the dimension concatenation layer 2106. In the dimension concatenation layer 2106, output from the output layer 2105 needs to be re-extracted. However, re-extraction of the output layer 2105 needs a large number of processes. The reason is that the processing amount of re-extraction increases as layers in the encoding layer proceed in the forward propagation direction. Thus, the method of holding thinned feature quantities in the SRAM is selected in the output layer 2103 and the output layer 2105. In the present embodiment, the method of re-extracting feature quantities is selected in the output layer 2101 nearest to input, and the method of holding thinned feature quantities in the SRAM is selected in the other output layers 2103 and 2105. However, selection methods are not limited thereto. It is possible to select either method that is preferable in each layer in view of the reduction amount of the SRAM storage space and processing efficiency. With either method, since feature quantity vectors is re-extracted in a case where skip connection is performed, feature quantity vectors do not need to be held and the use amount of the SRAM storage space can be reduced. In a case where training is performed, it is possible to learn feature quantity vectors equivalent to normal skip connection and perform inference at equivalent accuracy to optimize convolution coefficients, thereby obtaining the effects of the present application.

### Operation of Skip Connection

FIG. 14 is a flowchart illustrating re-extraction operation. The processing illustrated in FIG. 14 may be implemented by the CPU 104. The following describes an example in which the processing is executed by the CPU 104. Functions of some or all steps in FIG. 14 may be implemented by hardware such as ASICs or electronic circuits. Symbol “S” in description of each processing means a step in the flowchart diagram.

The processing illustrated in FIG. 14 is started with the CPU 104 starting management of skip connection. The CPU 104 determines whether processing reaches the intermediate layer 2004. If the processing reaches the intermediate layer 2004, the CPU 104 advances processing at S1401 to processing at S1402. If the processing does not reach the intermediate layer 2004, the CPU 104 continues processing at S1401. At S1402, the CPU 104 holds, in the SRAM 401, only a result at an event where the intermediate layer 2004 is reached. In other words, feature quantity vectors extracted in convolution layers on the preceding stage side of the intermediate layer 2004 are not held. At S1403, the CPU 104 obtains data from the DRAM 103 again. The data obtained by the CPU 104 from the DRAM 103 again is input data. At S1404, the CPU 104 sequentially advances processing from the input layer. Specifically, the CPU 104 calculates again feature quantity vectors extracted in convolution layers from the input layer to the output layer 2002. At S1405, the CPU 104 determines whether the output layer 2002 is reached. If the output layer 2002 is reached, the CPU 104 advances processing at S1405 to processing at S1406. If the output layer 2002 is not reached, the CPU 104 returns processing at S1405 to processing at S1404 and advances processing of extracting the feature quantity vector of each layer until the output layer 2002 is reached. At S1406, the CPU 104 dimensionally concatenates a result at the event where the intermediate layer 2004 is reached and a result at the event where the output layer 2002 is reached. Specifically, the CPU 104 dimensionally concatenates feature quantity vectors re-extracted until the output layer 2002 is reached and a feature quantity vector at the event where the intermediate layer 2004 is reached. During re-extraction, concatenation elements disposed between the intermediate layer 2004 and the post-upsampling layer 2005 wait for inputting of a re-extraction result. For example, buffers (delay elements) for re-extraction may be disposed between the intermediate layer 2004 and the concatenation elements. At S1407, the CPU 104 inputs the result of the dimensional concatenation to the post-upsampling layer 2005 and ends processing at S1401 to S1407. At S1401 to S1407, feature quantity vectors may be aggregated to a representative value as output data in a case where pooling layers are disposed on the subsequent stage side of convolution layers.

### Second Embodiment

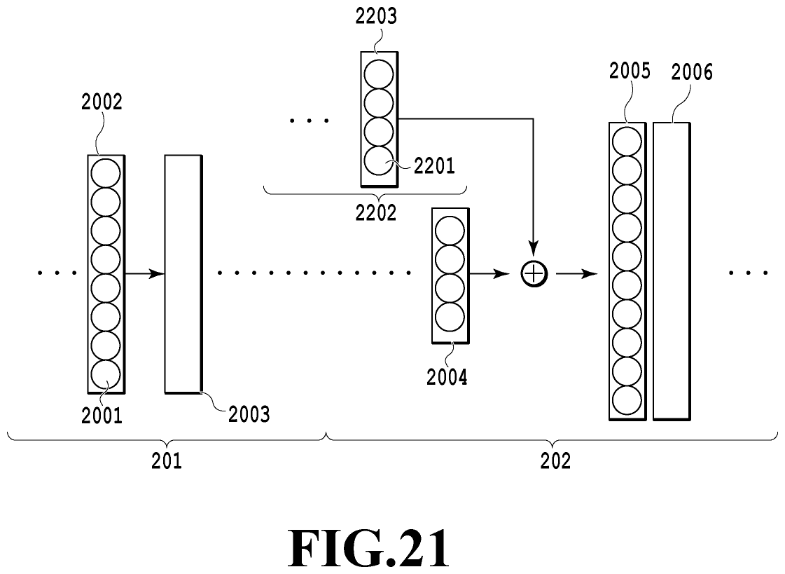

In the first embodiment described above, the method of thinning feature quantities and the method of not holding feature quantities in the SRAM but re-extracting them can be selected as the method of reducing the use amount of the SRAM storage space along with the skip connection. Regardless of which method is selected, the effect of reducing the use amount of the SRAM storage space is obtained. Feature quantity vectors passed to the next layer and thinned feature quantity vectors in the encoding layer are the same as feature quantity vectors used in dimension concatenation. Thus, determination accuracy decreases, which is a problem. In the present embodiment, a means capable of improving determination accuracy while reducing the use amount of the SRAM storage space is described. FIG. 21 is a schematic diagram for description of details of skip connection. In the present embodiment, an encoding layer 2202 is newly disposed. The encoding layer 2202 includes an optional output layer 2203. The output layer 2203 includes a plurality of artificial neurons 2201. Training of the CNN model in the present embodiment will be described below. In a case where an image is input to the CNN model, processing is executed in the forward propagation direction in each of the encoding layer 201 and the encoding layer 2202. For example, the output layer 2002 outputs an 8-channel feature quantity vector. The feature quantity vector output from the output layer 2002 is input to the next layer 2003 disposed on the subsequent stage side of the output layer 2002. In the decoding layer 202, a feature quantity vector is input from the intermediate layer 2004 to the post-upsampling layer 2005. In this case, an feature quantity vector output from the output layer 2203 in the encoding layer 2202 and the feature quantity vector output from the intermediate layer 2004 are dimensionally concatenated. In the first embodiment, the use amount of the SRAM storage space is reduced by applying the method of thinning feature quantities to the feature quantity vector output from the output layer 2002 and re-extraction of the feature quantity vector from the output layer 2002 in dimension concatenation. In the present embodiment, the number of channels, the data length, and the number of pixels of the feature quantity vector output from the output layer 2203 used for dimension concatenation can be designed to be equal to or smaller than those of a feature quantity vector thinned or re-extracted in the first embodiment. The reason is that the encoding layer 2202 can freely change the model structure. For example, a case where the size of the feature quantity vector output from the output layer 2203 is set to be the same as the size of the feature quantity vector thinned or re-extracted for dimension concatenation in the first embodiment will be described below. As a specific example, comparison is made with a case where the feature quantity vector output from the output layer 2002 is thinned from eight channels to four channels for dimensional concatenation with the feature quantity vector output from the intermediate layer 2004 in the first embodiment. In the first embodiment, four channels among the eight channels of the feature quantity vector output from the output layer 2002 are used for both input to the next layer 2003 and a feature quantity vector for dimension concatenation. Thus, in model training, optimization cannot be performed for either use, and the filter coefficients need to be determined so that an effective feature quantity vector is obtained in either use. However, in the present embodiment, the feature quantity vector output from the output layer 2002 is used only for input to the next layer 2003. The feature quantity vector output from the output layer 2203 is used in dimension concatenation with the feature quantity vector output from the intermediate layer 2004. These two feature quantity vectors can be each optimized during training, and thus it is possible to improve accuracy while suppressing the use amount of the storage space of the SRAM 401. In the present embodiment, the case where the size of the feature quantity vector output from the output layer 2203 is the same as the size of the feature quantity vector thinned or re-extracted in the first embodiment is described above. However, they do not necessarily need to be the same. In either case, re-extracting feature quantity vectors in performing skip connection eliminates the need to hold feature quantity vectors, thereby reducing the use amount of the SRAM storage space. In a case where training is performed, the encoding layer for feature quantity extraction and the encoding layer for skip connection are each separately subjected to training and the filter coefficients are optimized to contribute accuracy, and thus it is possible to perform inference at equivalent or more excellent accuracy, thereby obtaining the effects of the present application.

### Third Embodiment

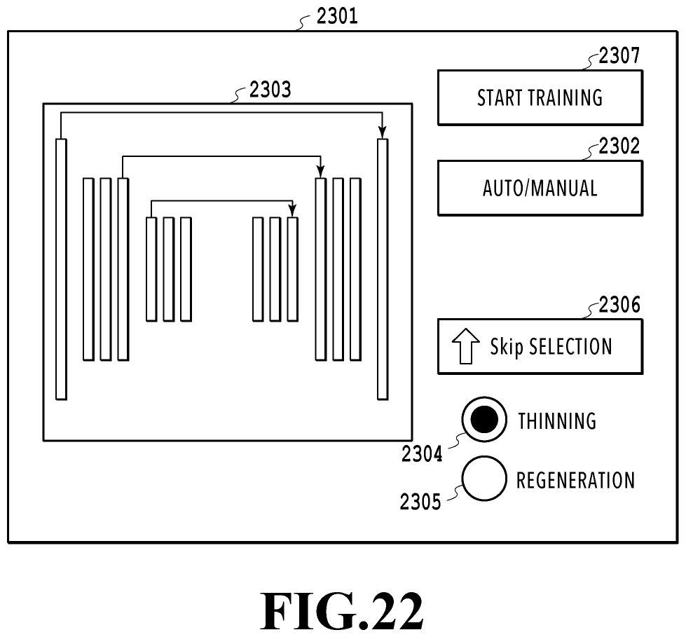

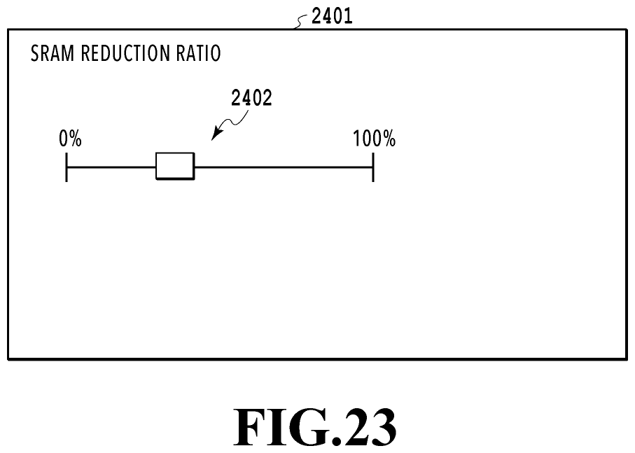

In the first embodiment described above, the method of thinning feature quantities and the method of not holding feature quantities in the SRAM but re-extracting them are indicated for each layer as the method of reducing the use amount of the SRAM storage space along with the skip connection. In a case where the method of thinning feature quantities is selected, it is needed to select which element to thin and to what extent based on the number of channels, the data length, and the number of pixels of a feature quantity vector. In the second embodiment, in addition to the above-described selection, it is needed to select the structure of the CNN model that outputs a feature quantity vector used in dimension connection. In both embodiments, the effect of reducing the use amount of the SRAM storage space is obtained. However, a user needs to select thinning target or thinning extent, and whether to perform re-extraction. In the present embodiment, a method of automatically performing selection along with reduction of the SRAM use amount while reducing the SRAM use amount will be described below. FIG. 22 is a diagram illustrating an example of a skip connection setting screen 2301 for training the CNN model. FIG. 22 illustrates the setting screen 2301. The setting screen 2301 functions as a user interface that receives operations from the user. Thus, the user can perform selection along with reduction of the use amount of the SRAM storage space through a setting screen 1301. A model designing auto/manual toggle button 2302 and a training start button 2307 are disposed in an upper-right region of the setting screen 2301. A selection button 2306, a thinning selection button 2304 and a regeneration selection button 2305 are disposed in a lower-right region of the setting screen 2301. A CNN model structure display screen 2303 is disposed in a left region of the setting screen 2301. The model designing auto/manual toggle button 2302 receives selection of whether to automatically or manually perform selection along with reduction of the use amount of the SRAM storage space. Although two kinds of selection, automatic selection and manual selection, are received in the present embodiment, some embodiments are not limited thereto. For example, more detailed selection such as manually setting part of model designing matter while automatically setting the other part may be received. Subsequently, a case where the model designing auto/manual toggle button 2302 is pressed down and selection along with reduction of the use amount of the SRAM storage space for the CNN model is automatically performed will be described below. In a case where the model designing auto/manual toggle button 2302 is pressed down, transition is made to a detailed setting screen for setting what criteria to use for automatic selection along with reduction of the use amount of the SRAM storage space. FIG. 23 is a diagram illustrating an example of the detailed setting screen for training the CNN model. On a detailed setting screen 2401, it is possible to mainly set the extent to which the use amount of the SRAM storage space along with the skip connection is reduced. A setting bar 2402 is disposed on the detailed setting screen 2401. The position of the setting bar 2402 can be changed between 0% to 100% by the user. A reduction ratio of the use amount of the SRAM storage space along with the skip connection is received through a user operate of the setting bar 2402, and the CPU 104 performs setting of designing matters of the CNN model based on the reduction ratio. The reduction ratio of the use amount of the SRAM storage space is received in the present embodiment, but some embodiments are not limited thereto. For example, the number of sum-of-products operations, the processing speed, and the use amount of the SRAM storage space may be received for the entire CNN model, and the CPU 104 may perform selection along with reduction of the use amount of the SRAM storage space for the CNN model based on them.

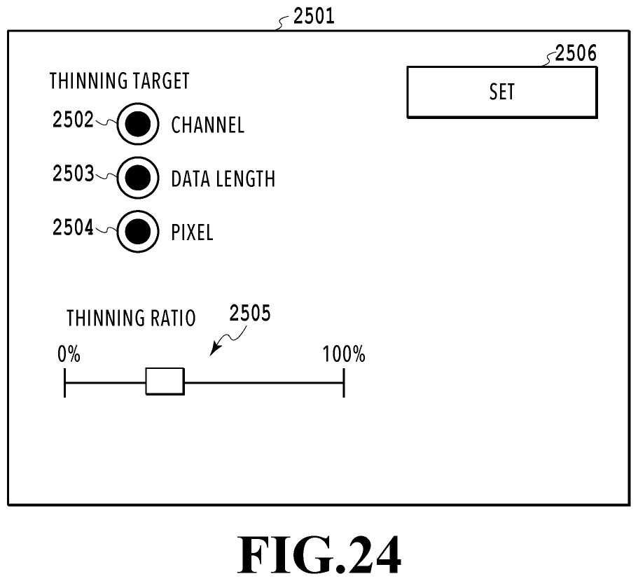

Subsequently, a case where a model designing auto/manual toggle button 1302 is pressed down and selection along with reduction of the use amount of the SRAM storage space for the CNN model is manually performed will be described below. A schematic diagram of the CNN model is displayed on a CNN model structure display screen 1303. In a case where selection along with reduction of the use amount of the SRAM storage space for the CNN model is manually performed, a method of reducing the use amount of the SRAM storage space based on skip connection can be set for each layer for which skip connection is performed. The thinning selection button 2304 and the regeneration selection button 2305 provide options for the method of reducing the use amount of the SRAM storage space, which is described above in the first embodiment. Specifically, the CPU 104 receives whether the user selects the method of thinning feature quantity vectors or the method of regenerating feature quantity vectors. In the present embodiment, two kinds of selections for the method of reducing the use amount of the SRAM storage space, which is described above in the first embodiment are received, but some embodiments are not limited thereto. For example, as described above in the second embodiment, selection of the method of reducing the use amount of the SRAM storage space, with which different filter coefficients are used between encoding and dimension concatenation may be received. For each layer for which skip connection is performed, it is possible to set the method of reducing the use amount of the SRAM storage space by selecting either the thinning selection button 2304 or the regeneration selection button 2305 and pressing down the selection button 2306. In a case where the thinning selection button 2304 is selected for each layer for which skip connection is performed and the selection button 2306 is pressed down, transition is made to a detailed setting screen for setting which element to thin and to what extent. FIG. 24 is a diagram illustrating another example of a detailed setting screen 2501 for training the CNN model. The detailed setting screen 2501 is a screen to which transition is made in a case where the thinning selection button 2304 is selected and the selection button 2306 is pressed down. A set button 2506 is disposed in an upper-right region of the detailed setting screen 2501. A channel selection button 2502, a data length selection button 2503, and a pixel selection button 2504 are disposed in an upper-left region of the detailed setting screen 2501. In a lower-left region of the detailed setting screen 2501, the channel selection button 2502, the data length selection button 2503, and the pixel selection button 2504 each receive selection of which element to thin for reduction of the use amount of the SRAM storage space. A setting bar 2505 operates in accordance with each button disposed in the lower-left region of the detailed setting screen 2501. Specifically, in a case where the channel selection button 2502 is selected, the ratio of thinning an element that is channel is received. In a case where the data length selection button 2503 is selected, the ratio of thinning an element that is data lengths is received. In a case where the pixel selection button 2504 is selected, the ratio of thinning an element that is pixel is received. After either one is selected and the setting bar 2505 is operated, selected setting for reduction of the use amount of the SRAM storage space can be set to a layer for which skip connection is performed by pressing down the set button 2506. FIG. 22 is referred again. For training the CNN model in which the use amount of the SRAM storage space is reduced, training of the CNN model is started as setting is input and the training start button 2307 is pressed down. In the present embodiment, an example of the setting screen 2301 in a case where the CNN model in which the use amount of the SRAM storage space along with the skip connection is reduced is trained is described. However, items that can be set are not limited thereto. For example, a means that inputs training conditions for performing training, a means that interrupts training halfway through, and a means that executes inference may be provided. Moreover, screen forms are not limited to the present form, but disposition and an input means may be different from those in the present embodiment.

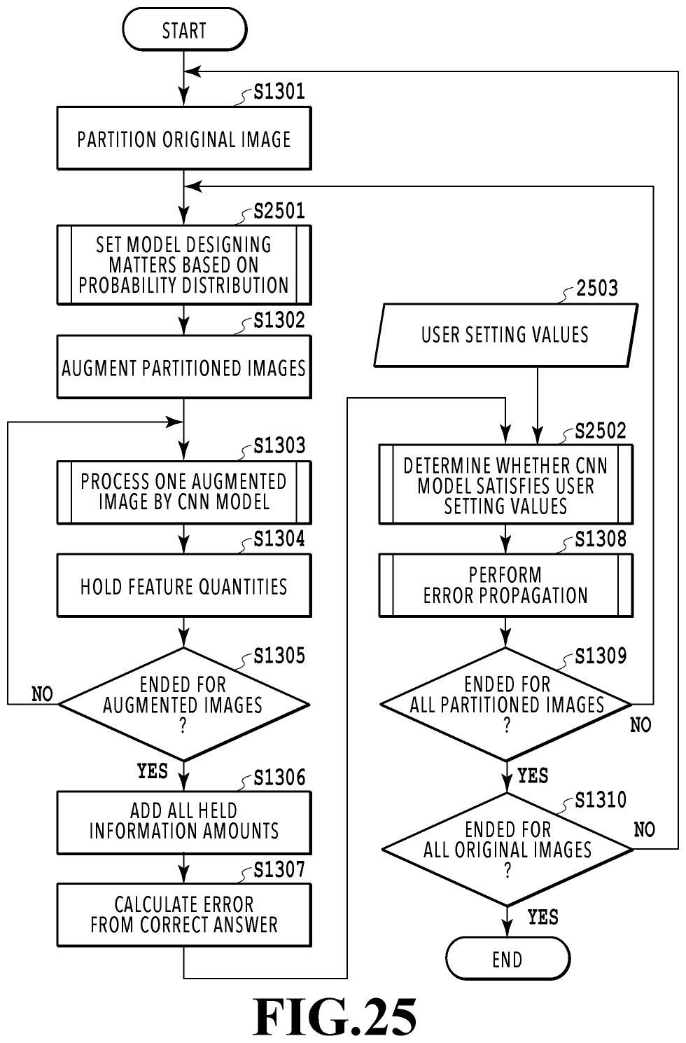

Subsequently, an example of the method of automatically performing selection along with reduction of the use amount of the SRAM storage space for the CNN model will be described below. Typically, a method known as neural architecture search (NAS) is available as a method of searching CNN models with high accuracy. With this method, it is possible to search the structure of a model with high accuracy and selection along with reduction of the use amount of the SRAM storage space. The reason is that the quality of setting values of a model structure or designing matter can be reflected on error in a process where training is performed. FIG. 25 is a flowchart illustrating automated CNN model designing. The processing illustrated in FIG. 25 may be implemented by the CPU 104. The following describes an example in which the processing is executed by the CPU 104. Functions of some or all steps in FIG. 25 may be implemented by hardware such as ASICs or electronic circuits. Symbol “S” in description of each processing means a step in the flowchart diagram.

The processing illustrated in FIG. 25 is started based on input from a training start button 1307 by the user. In the processing illustrated in FIG. 25, the same processing as in the processing illustrated in FIG. 13 is referred to as the same step, and description thereof will be omitted. At S2501, the CPU 104 sets model designing matters based on a probability distribution. The model designing matters are, for example, matters such as the model structure and selection along with reduction of the use amount of the SRAM storage space. The model structure is the model architecture and is a structure specified by, for example, SegNet, U-Net, or ResNet. The probability distribution may be a random distribution at the initial stage of training. The probability distribution changes so that setting value for reducing the error from correct answer calculated at S1307 are more likely to be selected as training proceeds. At S2502, the CPU 104 receives user setting values in FIG. 25, set by the user through the setting screen 1301. The CPU 104 determines whether the set CNN model satisfies the user setting values in FIG. 25. The term “penalty” is defined here. The penalty is an evaluation indicator reflecting whether the CNN model set at S2501 satisfies the user setting values in FIG. 25. In the present embodiment, the value of the penalty is zero in a case where the CNN model satisfies the user setting values in FIG. 25. In a case where the CNN model does not satisfy the user setting values in FIG. 25, the value of the penalty increases in accordance with the size of deviation from the user setting values in FIG. 25. For example, in a case where the reduction ratio of the use amount of the SRAM storage space along with the skip connection is set to 50% by the user, this setting value is input to S2502 as the user setting values in FIG. 25. At S2501, the CPU 104 sets the method of reducing the use amount of the SRAM storage space for each layer for which skip connection is performed. Thus, it is possible to calculate the extent to which the use amount of the SRAM storage space can be reduced as compared to a case where no reduction is applied. The CPU 104 compares this value with the user setting values in FIG. 25 and uses output at S1307 directly for S1308 in a case where the user setting values in FIG. 25 are satisfied. In a case where the user setting values in FIG. 25 is not satisfied, the CPU 104 reflects the value of the penalty on output at S1307 and uses it for S1308. The reason is that it is needed to set combination of the setting values selected at S2501 to be less likely to be selected. For example, there is a method of not applying the penalty in a case where the reduction ratio of the use amount of the SRAM storage space is 50% or higher but adding the penalty in accordance with the insufficient reduction ratio in a case where the reduction ratio is lower than 50%. In the present embodiment, the penalty is added to output at S1307. However, application of the penalty is not limited thereto. For example, output at S1307 may be multiplied in accordance with the insufficient reduction ratio. With this operation, the value used at S1308 is a value reflecting the quality of selection along with reduction of the use amount of the SRAM storage space, which is set at S2501 in addition to determination performance of the CNN model. Through the error backward propagation performed at S1308, it is possible to optimize the convolution coefficients of the CNN model and selection along with reduction of the use amount of the SRAM storage space, which is set at S2501. In the present embodiment, processing at S2502 is executed between S1307 and S1308, but some embodiments are not particularly limited thereto. The evaluation at S2502 may be performed anywhere between S1301 to S1308. Also, while processing between S1301 to S1310 is repeated, S2502 does not necessarily need to be performed at each repetition. In any case, re-extracting feature quantity vectors in performing skip connection eliminates the need to hold feature quantity vectors, thereby reducing the SRAM use amount. Moreover, in a case where training is performed, selection along with reduction of the use amount of the SRAM storage space is automatically learned and convolution coefficients, model structure, and setting values are optimized to contribute accuracy, and thus it is possible to suppress accuracy decrease and obtain effects.

Although various examples and embodiments of the present disclosure are described above, the scope and range of the present disclosure are not limited to particular description in the present specification.

For example, an example of a CNN model including an encoding layer and a decoding layer is described above in the embodiments. In addition, the method of reducing the use amount of the SRAM storage space along with dimension concatenation is described above with an example of dimension concatenation of output from an output layer in the encoding layer and output from an intermediate layer in the decoding layer. However, the CNN model does not necessarily need to include the encoding layer and the decoding layer. For example, dimension concatenation can be performed in a CNN model including the encoding layer but not including the decoding layer. Also, outputs from two or more output layers in the encoding layer are dimensionally concatenated and set as input to the next layer in some cases. In such a CNN model as well, the effect of reducing the use amount of the SRAM storage space can be obtained by a method used in the above-described embodiments as the method of reducing the use amount of the SRAM storage space along with dimension concatenation.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-043531, which was filed on Mar. 19, 2024 and which is hereby incorporated by reference wherein in its entirety.

What is claimed is:

1. An information processing apparatus comprising:
at least one memory storing a plurality of convolution layers; and
a processor connected to the at least one memory,
wherein the processor
propagates output data based on a feature quantity vector extracted from input data from a preceding stage side at each of the plurality of convolution layers to a subsequent stage side,
concatenates a forward propagation path that sequentially propagates the output data through each convolution layer between some convolution layers with other convolution layers among the plurality of convolution layers and a bypass path that bypasses the forward propagation path in a case of propagating the output data from the some convolution layers to the other convolution layers,
performs processing of extracting the feature quantity vector from the input data at each of the plurality of convolution layers,
in the processing of extracting the feature quantity vector, performs, as re-extraction processing, processing of re-extracting the feature quantity vectors included in convolution layers up to a convolution layer where bypassing through the bypass path starts among the plurality of convolution layers, and
in a case where the re-extraction processing is performed in the processing of extracting the feature quantity vector, concatenates an output result from the forward propagation path with a result of the re-extraction processing performed by the processing of extracting the feature quantity vector in the concatenating of the forward propagation path and the bypass path.

2. The information processing apparatus according to claim 1, wherein
the input data is constituted by a plurality of pixels,
each of the plurality of convolution layers includes a filter in which a plurality of convolution coefficients are specified, and
the processor extracts the feature quantity vector by performing convolution processing based on the plurality of pixels and the plurality of convolution coefficients at each of the plurality of convolution layers.

3. The information processing apparatus according to claim 2, wherein
a convolution layer set including the plurality of convolution layers includes a plurality of pooling layers, and
each of the plurality of pooling layers is disposed on the subsequent stage side of the corresponding each of the plurality of convolution layers and aggregates the feature quantity vectors into a representative value as the output data.

4. The information processing apparatus according to claim 3, wherein the at least one memory further stores an upsampling layer disposed on the subsequent stage side of the convolution layer set and configured to expand the output data, wherein
in the upsampling layer, the processor increases a size of the representative value to a size of the input data by extending the output data and outputs the output data as subsequent stage data.

5. The information processing apparatus according to claim 4, wherein the at least one memory further stores an activation layer disposed on the subsequent stage side of the upsampling layer and configured to re-configure subsequent-stage image data in which the subsequent-stage data is mapped, wherein
the processor classifies a subject appearing in image data constituted by the plurality of pixels based on the subsequent stage image data reconstructed by the activation layer.

6. The information processing apparatus according to claim 3, wherein the at least one memory further stores an activation layer disposed at the subsequent stage side of the convolution layer set and configured to re-configure subsequent-stage image data in which the representative value is mapped, wherein
based on the subsequent-stage image data re-configured by the activation layer, the processor classifies a subject captured in image data formed by the plurality of pixels.

7. The information processing apparatus according to claim 5, wherein
each of the plurality of convolution layers includes a plurality of artificial neurons,
each of the plurality of artificial neurons
performs the convolution processing using the convolution coefficients, and
based on a result of the convolution processing, calculates feature quantities that are constituent components of the feature quantity vector, and
the processor finds the convolution coefficients based on the input data and the subsequent stage image data re-configured by the activation layer.

8. The information processing apparatus according to claim 2, wherein the processor performs a sum-of-product operation on the input data while shifting the filter with a certain stride to find feature quantities representing local features of the input data at every shift of the filter, and extracts a set of the feature quantities as the feature quantity vector.

9. The information processing apparatus according to claim 1, wherein
the at least one memory includes
a first memory device functioning as main memory, and
a second memory device functioning as cache memory,
the first memory device stores the input data, and
the second memory device stores the feature quantity vector extracted at each of the plurality of convolution layers.

10. The information processing apparatus according to claim 9, wherein in performing the re-extraction processing, the processor obtains the input data from the first memory device.

11. The information processing apparatus according to claim 9, wherein
the first memory device is formed of DRAM, and
the second memory device is formed of SRAM.

12. The information processing apparatus according to claim 2, wherein divided data obtained by dividing image data formed of the input data into certain spatial regions is inputted to the convolution layer set.

13. An information processing method for an information processing apparatus including a plurality of convolution layers, the information processing method comprising:
propagating output data based on a feature quantity vector extracted from input data from a preceding stage side at each of the plurality of convolution layers to a subsequent stage side;
concatenating a forward propagation path that sequentially propagates the output data through each convolution layer between some convolution layers and other convolution layers among the plurality of convolution layers with a bypass path that bypasses the forward propagation path in a case of propagating the output data from the some convolution layers to the other convolution layers; and
performing processing of extracting the feature quantity vector from the input data at each of the plurality of convolution layers, wherein
the performing the processing includes performing, as re-extraction processing, processing of re-extracting the feature quantity vectors included in convolution layers up to a convolution layer where bypassing through the bypass path starts among the plurality of convolution layers, and
the concatenating includes, in a case where the re-extraction processing is performed in the performing the processing, concatenating an output result from the forward propagation path with a result of the re-extraction processing performed in the performing the processing.

14. A non-transitory computer-readable storage medium storing a computer-executable instructions for causing a computer to execute:
propagating output data based on a feature quantity vector extracted from input data from a preceding stage side at each of a plurality of convolution layers to a subsequent stage side;
concatenating a forward propagation path that sequentially propagates the output data through each convolution layer between some convolution layers and other convolution layers among the plurality of convolution layers with a bypass path that bypasses the forward propagation path in a case of propagating the output data from the some convolution layers to the other convolution layers; and
performing processing of extracting the feature quantity vector from the input data in each of the plurality of convolution layers, wherein
in the processing of extracting the feature quantity vector, processing of re-extracting the feature quantity vectors included in convolution layers up to a convolution layer where bypassing through the bypass path starts among the plurality of convolution layers is performed as re-extraction processing, and
in the concatenating the forward propagation path with the bypass path, in a case where the re-extraction processing is performed by the processing of extracting the feature quantity vector, an output result from the forward propagation path with a result of the re-extraction processing performed by the processing of extracting the feature quantity vector are concatenated.
